(19) United States
(12) Patent Application Publication
(10) Pub. No.: US 2026/0316496 A1
(43) Pub. Date: Oct. 15, 2026

(54) TIRE CHARACTERISTICS MANAGEMENT SYSTEMS FOR A VEHICLE AND METHOD FOR OPERATING THE SAME

(71) Applicant: Andino Technologies LLC, Sheridan, WY (US)

(72) Inventors: Nicholas Hastreiter, Marshfield, WI (US); Mirabel Vranjkovic, Sheridan, WY (US)

(21) Appl. No.: 19/643,473

(22) Filed: Apr. 9, 2026

Related U.S. Application Data
(60) Provisional application No. 63/785,807, filed on Apr. 9, 2025.

(51) Int. Cl. B60C 23/00; B60C 23/04; B60C 23/10

(52) U.S. Cl. CPC B60C 23/002; B60C 23/00318; B60C 23/0486; B60C 23/10; B60C 2200/10

(57) ABSTRACT

The application relates to a tire pressure management system for vehicles, such as motorcycles, with an electrically powered compressor mounted on the rim, a bidirectional valve unit, a control unit, and an inductive power supply. The system may dynamically adjust tire pressure based, for example, on riding modes, weight parameters, and road conditions. A sensor system can monitor, for example, tire pressure, road characteristics, and vehicle dynamics, enabling automated or user-controlled adjustments. An integrated reservoir may allow for rapid pressure changes, while an automated sealing system with a sealant reservoir and injection mechanism may provide puncture protection. The inductive power system may ensure wireless energy transfer.

### CROSS-REFERENCE TO RELATED APPLICATIONS

This application claims the benefit of U.S. Provisional Patent Application No. 63/785,807, titled “Tire Characteristics Management Systems for a Vehicle and Method for Operating the Same,” filed on Apr. 9, 2025.

This application incorporates the entire contents of the foregoing application(s) herein by reference.

### TECHNICAL FIELD

Various embodiments relate generally to a tire pressure management system for a vehicle and a method for operating the same. Additionally, some embodiments pertain to a system, which provides automated tire sealing. Further embodiments are directed to an electric tire heating system for a vehicle.

### BACKGROUND

Vehicles are typically equipped with pneumatic tires that require a proper tire pressure level to ensure optimal performance, safety, and efficiency. Maintaining the correct tire pressure is essential for reducing tire wear, improving fuel efficiency, and enhancing vehicle stability and handling.

However, tire pressure can fluctuate due to environmental factors, road conditions, and gradual air leakage, necessitating frequent monitoring and manual adjustments by the user. Additionally, the optimal tire pressure depends on external or operational factors, such as variations in passenger load, increased weight, or different road surfaces, and must be adjusted accordingly when these conditions change.

The term “vehicle” as used herein may refer to any type of motorized transport, including but not limited to passenger cars, trucks, motorcycles, off-road vehicles, and commercial transport vehicles. Depending on the application, different tire pressure management strategies may be required to accommodate varying operational conditions and performance requirements.

The simplest and most common way to adjust tire pressure is through manual inspection and subsequent manual inflation of the tires, for example, at a gas station. However, the prior art also includes automated systems and methods in which a means for introducing air is directly integrated into the wheel and/or tire.

Nevertheless, there remains a need for improvements in tire pressure management systems for vehicles, particularly for motorcycles.

### SUMMARY

In general, the present application relates to a tire pressure management system for a vehicle. The tire pressure management system may comprise an electrically powered compressor mounted on a rim, a valve unit, a power supply system for providing electrical power to the compressor and a control unit for controlling the compressor and the valve unit. An advantage of the disclosed tire pressure management system is that it enables automatic and precise tire pressure adjustments without requiring an external air supply, allowing for significantly faster and more convenient pressure adjustments for the vehicle operator. Furthermore, the system also facilitates real-time pressure adjustments while driving, enabling dynamic adaptation to changing conditions.

As used herein, the term “electrically powered compressor” may refer to a compact, motor-driven air or fluid compression unit that can be mounted on the rim and operates using electrical energy supplied either by the vehicle's power system or an independent battery. The compressor may be configured to generate pressurized air or fluid for inflating or adjusting tire pressure as needed. It may include components such as a miniature rotary or diaphragm compressor or pump, an electric motor, an intake valve, and an outlet valve all of which can be enclosed within a compressor housing. The compressor may be designed for efficient operation within the constrained space of the wheel assembly, ensuring compact integration within the rim structure. It is further optimized to minimize vibration, weight impact, and energy consumption while maintaining reliable tire pressure regulation.

A rim may comprise the outer circular structure of a wheel or wheel assembly that supports and secures the tire or tire casing. More precisely, the rim may form the outer edge of a wheel and may provide the mounting surface for the tire, ensuring proper seating and air retention. It may serve as the interface between the tire and the wheel assembly, transmitting mechanical loads while maintaining stability.

On a motorcycle wheel, for example, the rim is typically connected to the hub via spokes (in spoked wheels) or may be integrated as part of a cast or forged one-piece wheel design.

The rim may have a cross-section with a U-shaped profile, where the center portion is deeper than the edges. The elevated edges flanking this deeper section, known as rim flanges, provide structural support and help secure the tire. The deeper center, referred to as the rim well, plays an important role in tire mounting and demounting. During installation, the tire bead can move into the rim well, reducing the force required to stretch the tire over the rim flanges. This is particularly important for tubeless tires, as it ensures a secure fit while maintaining an airtight seal. The depth and shape of the rim well may vary depending on the wheel and tire combination, with some designs incorporating deeper wells for ease of installation. In certain high-performance or off-road applications, rims may also feature bead retention structures or specialized well profiles to enhance tire security under extreme conditions.

For clarification, in the present application, the term “rim” may also refer to the entire structure or wheel assembly on which the tire or tire casing is mounted, potentially including components such as the hub and spokes, depending on the specific wheel configuration.

The rim is typically made of metal alloys or composite materials to withstand high mechanical loads and environmental stresses.

Generally, a tire may be a flexible, ring-shaped component mounted on a wheel or wheel assembly to provide traction, load support, and cushioning for a vehicle. It can be made of rubber and can be reinforced with fabric or metal layers to enhance durability and performance under various conditions. A tire may comprise multiple structural elements, including a tire casing, which can form its main body and provide strength and flexibility, and a tire cavity, which may serve as the internal space that holds pressurized air or another inflation medium. The design and composition of a tire can influence performance factors such as grip, rolling resistance, and ride comfort, making it an important element in vehicle dynamics and efficiency.

As mentioned above, the compressor may be mounted on the rim, referring to the installation of an electrically powered compressor directly onto the wheel's rim structure. This mounting configuration ensures that the compressor remains integrated with the rotating wheel while maintaining stable operation.

The compressor can be attached to the rim using a form-fit, force-fit, and/or material-fit connection. A form-fit connection can be achieved by securing the compressor within a designated recess or a specifically shaped housing in the rim well, ensuring stability through interlocking geometries. Molded integration, snap-fit elements, or dovetail joints are examples of this approach. A force-fit connection may be implemented using a clamping system or friction-based connections, such as a high-tension bracket that holds the compressor in place due to applied force. Screwed or bolted connections with preload tension also fall under this category. A material-fit connection, on the other hand, may involve permanently affixing the compressor to the rim through bonding, welding, or adhesive connections, creating a material-integrated structure without requiring additional mechanical fasteners.

For example, the electrically powered compressor can be mounted on a rim and encased within a tire casing, configured to compress a fluid for adjusting tire pressure.

Since the term “rim” may also refer to the entire structure on which the tire is mounted, the phrase “the compressor is mounted on the rim” may encompass configurations where the compressor is attached to the spokes, the hub, or other structural components of the wheel. In other words, the term “rim” may refer to the entire wheel assembly, excluding the rubber tire casing.

In some embodiments, the compressor may also be mounted on components that are attached to the rim, such as the valve stem or the valve unit. This configuration allows for direct integration with the tire inflation and deflation system, enabling precise pressure regulation while utilizing existing structural elements for mounting.

The electric motor of the compressor may comprise a rotational axis about which a rotor rotates relative to a stator. This rotational axis may be oriented substantially parallel to the wheel assembly axis, i.e., the axis about which the rim and/or tire and/or hub rotates when the vehicle is in motion.

In an exemplary embodiment, the compressor is integrated into a manifold. The manifold may be formed as a compact structural housing that mechanically and functionally combines multiple components of the system, including the compressor, the valve unit or the valves, and/or the valve stem. This configuration allows for a close coupling of all essential pneumatic components within a single unit. The valve stem may include a threaded section, into which or onto which the housing of the manifold can be screwed, thereby enabling direct mounting to the rim or into an opening formed in the rim wall. The threaded section of the valve stem may be arranged on the radially outer side of the rim wall, such that the manifold can be mounted from the outside of the rim. In this configuration, the thread may be formed as an external thread on the valve stem, enabling the manifold to be screwed on directly and securely. This threaded connection ensures a compact and robust mechanical interface between the valve stem and the manifold housing, while allowing for easy assembly and disassembly from the outer side of the wheel. The valve stem may be a conventional type with a modified or extended threaded section adapted for external mounting of the manifold.

Alternatively, the manifold housing may be configured with a bayonet connection, a clamping mechanism, or a quick-release interface to facilitate simplified installation.

The manifold may further comprise internal channels or cavities in the housing that guide pressurized air between the compressor, the valve unit or the valves, and/or the valve stem. These internal channels or cavities may also provide fluid communication from the tire to the outside environment, for example when the valve unit comprises a deflation valve. In such a configuration, air can be selectively released from the tire through the manifold, enabling both inflation and deflation functions to be integrated into a single, compact unit.

As a result, external tubing can be omitted, which simplifies the construction and improves robustness. Sealing elements such as O-rings or elastomeric gaskets may be arranged at the component interfaces to ensure airtight and reliable operation.

Through the integration of these components into a single manifold structure, the system benefits from a reduced spatial footprint and a simplified installation and maintenance process. The number of interfaces and potential leakage points is minimized, thereby increasing overall reliability and environmental resistance. Furthermore, the manifold may be designed as a modular unit that can be preassembled and functionally tested before being mounted to the rim, which simplifies production workflows and improves quality control.

In certain embodiments, the manifold may also incorporate electronic components, such as pressure sensors, sensor systems, or control electronics (e.g., a control unit). These components may be connected to a central control unit via electrical lines or wireless interfaces.

The compressor may be coupled to a one-way check valve fluidly connected to the valve stem. This ensures that air can be delivered into the tire but cannot flow back through the compressor when it is not operating. The one-way check valve may be configured as a separate component positioned between the compressor outlet and the valve stem, or it may be integrated directly into the compressor housing or incorporated into the manifold structure. Such integration enables a more compact design and reduces the number of external connections, thereby improving reliability and ease of assembly. The check valve may be of passive mechanical type (e.g., spring-loaded flap or ball valve), or it may be electronically actuated in synchronization with the compressor operation, depending on system requirements.

It is apparent that the one-way check valve forms part of the valve unit of the system.

The valve unit may be a component that regulates the flow of air between the compressor, the tire, and the external environment, enabling both inflation and deflation as required for precise tire pressure adjustments.

In an example embodiment a valve unit enables bidirectional fluid flow to regulate tire pressure, operatively coupled to the compressor to establish fluid communication between the compressor and the external atmosphere. A valve unit may generally refer to either a single valve or a system of interconnected valves that are in fluid communication with one another.

The term “fluid” in the context of this disclosure includes not only air, but also other gases or gas mixtures, such as nitrogen.

The valve unit may comprise a deflation valve, which is configured to release fluid from the tire casing to reduce tire pressure. In this respect, the deflation valve may comprise an electric controlled valve being in signal communication with the control unit of the tire pressure management system. This signal communication allows the control unit to regulate the electronically controlled deflation valve, enabling precise and automated pressure adjustments.

Furthermore, the valve unit may comprise a valve stem operatively coupled with the deflation valve and/or the compressor and/or the one-way check valve, wherein the valve stem can both admit and release fluid. The valve stem may be passed through an opening in the rim or rim well, and the compressor and/or the deflation valve and/or the one-way check valve and/or the manifold are directly mounted on the valve stem. This configuration enables seamless integration with conventional systems, as traditional setups already include a valve stem, allowing for straightforward upgrades and enhancements without requiring significant modifications to existing wheel assemblies.

The power supply system may be designed to provide electrical energy to the compressor. It may, for example, be an independent battery separate from the vehicle's power source or be directly connected to the vehicle's battery, supplying power to the compressor as needed. Additionally, other power supply systems independent of the vehicle battery may be considered, such as a solar-powered system with small integrated solar panels that generate energy for the compressor, or a dynamo-based generator similar to those used in bicycles, where rotational energy from the wheel is converted into electrical power to operate the compressor in real-time. However, the present application is not limited to these examples and may encompass other suitable power supply systems.

In an example embodiment, the power supply system may be a transformer-based inductive power supply system. The transformer-based inductive power supply system may comprise a first coil positioned at the vehicle axle and a second coil attached to the hub of the rim.

The first coil may be positioned at a motorcycle axle, allowing for efficient and contactless power transmission while accommodating the rotational movement of the wheel.

The first coil may be configured to generate a magnetic field, while the second coil is designed to inductively receive power from the first coil during operation and supply it to the compressor. In other words, the first and second coils are operatively coupled.

The first coil may be connected to a power source, enabling it to generate a magnetic field. For example, the first coil can be connected to a power source of the vehicle, particularly to a battery. The second coil may be connected to the electrically powered compressor and/or the control unit of the tire pressure management system, supplying both with electrical power.

Power is induced in the second coil as it moves within the magnetic field of the first coil during vehicle operation. Alternatively, power can also be induced when the vehicle is stationary by supplying the first coil with an alternating current (AC), thereby generating a time-varying magnetic field. If the first coil is connected to the vehicle's battery, which typically provides direct current (DC), a DC-to-AC converter (such as an inverter) would be required upstream of the first coil to ensure the generation of an alternating magnetic field.

In alternative embodiments, the first coil may also be replaced by a permanent magnet, which can induce a current in the second coil as the wheel rotates, providing an alternative means of power generation.

The first coil may comprise a plurality of windings applied around the circumference of the axle. For example, a spacer may be positioned between the two bearings located on either side of the axle. The spacer may have a diameter corresponding to the inner race of the bearings and provides lateral structural support to reduce bearing wear during cornering and other riding conditions that generate lateral forces. The spacer may float freely on the axle but may be held firmly in place once the bearings are pressed into position, ensuring a snug fit. The hub may be mounted onto the outer races of the bearings, while the inner races may be mounted onto the axle. The first coil may be integrated within the spacer, allowing for efficient inductive power transfer while maintaining the structural and functional integrity of the wheel assembly.

In an exemplary embodiment, the axle may be hollow and comprise axle walls that define an interior cavity. A first cable, extending from the vehicle's power source, may be routed through the interior cavity of the axle. The first coil may be electrically connected to the first cable through an opening in the axle wall, enabling a compact and protected wiring arrangement while minimizing external exposure to environmental factors.

The transformer-based inductive power supply system can additionally be configured to transmit bidirectional signals, such as control signals, enabling communication between the vehicle and the tire pressure management system. This can be achieved using methods such as pulse-code modulation, frequency shift keying, or other modulation techniques that allow data transmission over the inductive coupling.

By integrating bidirectional signal transmission, the system can facilitate real-time monitoring and adjustment of tire pressure, enable status feedback from sensors, and support diagnostic functions. This enhances overall system efficiency by reducing the need for separate wired communication pathways, making the setup more robust and reliable in demanding environments.

In a further exemplary embodiment, the second coil may be connected to the compressor via a second cable, which is routed radially outward from the hub of the rim to the compressor and/or control unit of the tire pressure management system. The compressor and control unit may be located within the rim well, which includes an opening through which the second cable is routed.

The first and second cables may comprise, in addition to wires for transmitting power, wires for bidirectional signal transmission.

In a further exemplary embodiment, the second coil may be integrated into a bearing assembly that is positioned in the hub of the rim and allows the rim to rotate around the axle. The second coil may be positioned in the bearing assembly such that a magnetic field generated by the first coil induces a current in the second coil when the rim rotates. In this respect, the second coil may be integrated within the bearing assembly in such a way that it surrounds the first coil when the rim is mounted on the axle.

Moreover, the power supply system may comprise a slip ring instead of inductive coils. The slip ring may include a stationary part—such as the brushes—which is mounted on the axle, and a rotating part—such as the conductive rings—which is mounted on the hub. A first cable may be connected to the stationary brushes, providing electrical contact to the vehicle's battery, while a second cable may be connected to the rotating rings, supplying power to the electrically powered compressor mounted on the rotating wheel assembly.

This configuration establishes a direct wired connection between the vehicle battery and the rotating compressor, allowing for reliable power transfer even during continuous wheel rotation. The use of brush-and-ring contact elements ensures continuous electrical connectivity while accommodating relative motion between the axle and hub.

In addition to supplying electrical power, the slip ring may also enable signal transmission. For example, the stationary brushes may be connected to the vehicle's control system and/or a user interface, while the rotating rings may be connected to the compressor's control unit. This allows for bidirectional communication—such as sending control commands to the compressor or receiving sensor feedback.

In an alternative embodiment, the power supply system may be configured to transfer electrical energy from the vehicle battery to the rotating compressor unit via the bearing assembly of the wheel. This approach can provide a compact and efficient solution that does not require separate slip rings or inductive coils.

For electrical current to pass through a bearing, there may be an electrical path between the inner and outer races via the rolling elements, such as steel balls. Although standard bearings are primarily designed for mechanical load transfer, they can also serve as part of an electrical conduction path.

To support this function, the contact surfaces between the races and the rolling elements may allow for sufficient electrical conductivity. This can be enhanced by using conductive grease, which may establish a more stable electrical connection. The conductive grease may comprise a lithium complex base mixed with fine conductive particles, such as graphene, graphite, or copper powder.

In addition, it may be possible to electrically insulate the bearing races from their surrounding structures. Specifically, the inner race may be insulated from the axle, and the outer race from the hub. Without such insulation, current may bypass the intended electrical path through the bearing. This insulation can be realized through non-conductive materials, such as ceramic sleeves, insulating bushings, or durable surface coatings.

In another variant, ceramic bearings may be used. These are inherently non-conductive, and may be combined with metal-coated rolling elements or arranged in a hybrid configuration, such as metal balls in ceramic races, to selectively introduce electrical conductivity where needed.

While not traditionally used for this purpose, bearings can thus be adapted to serve as a compact and robust power transfer element, particularly in applications where continuous rotation or limited installation space may restrict the use of conventional wiring or slip ring systems.

The control unit of the tire pressure management system may include a data processing unit with a memory and a communication module, enabling data or signal communication with the compressor and/or the valve unit, as well as their respective control modules. Additionally, the control unit may be in data communication with a user interface and/or the vehicle's control system to facilitate seamless integration and user control.

In some embodiments, the vehicle's control system or unit may act as the control unit of the tire pressure management system.

In particular, the control unit may comprise a microprocessor and can be in signal communication with the compressor and/or the valve unit. The control unit may be configured to receive user commands to manually adjust the tire pressure by controlling the compressor and/or the valve unit based on the commands. Additionally, it may be configured to automatically regulate the compressor and/or the valve unit based on input from one or more sensors that can detect parameters including, but not limited to, tire pressure, temperature, or load conditions. This allows for a flexible and adaptive tire pressure management system that enhances both user control and automated functionality to optimize performance, efficiency, and safety under varying operational conditions.

The memory may store instructions that, when executed by the microprocessor, cause the microprocessor to carry out various operations described in the present disclosure.

In this context, the control unit may be in signal communication with a user interface, which is configured to receive input from a user. The user interface may comprise a mechanical input device, such as a button, a touch display for entering signals, and/or a microphone for receiving audio commands. Additionally, the user interface may include a mechanical output device, such as a vibration motor, a display for presenting visual signals, or a speaker for outputting audio signals.

The user interface may be coupled to the first cable, while the control unit may be coupled to the second cable, enabling signal communication through inductive signal transmission via the first and second coils and/or through wireless communication, such as Bluetooth®. This configuration allows for seamless interaction between the user and the tire pressure management system, providing both manual input options and real-time feedback.

In another example, the control unit may be the vehicle's control system or unit. In this case, the user interface may be coupled to the vehicle's control unit, which in turn is connected to the first cable and the first coil. The compressor, valve unit, and one or more sensors may be coupled to the second cable, which is connected to the second coil. Bidirectional signal communication between the compressor, valve unit, sensors and vehicle's control unit may be achieved via inductive signal transmission. Alternatively, wireless communication, such as Bluetooth®, may be used, provided that all components include a communication module to enable direct data exchange.

In some embodiments, wireless communication may function parallel to or as an alternative to inductive signal transmission. In this case, the inductive coupling between the first and second coils may be used primarily for power transmission, while all control signals and sensor data are exchanged exclusively via a wireless communication protocol such as Bluetooth®, Wi-Fi®, or another radio-frequency-based system. This setup allows for increased flexibility in system design, as it eliminates the need for signal transmission through the inductive coupling. Additionally, a purely wireless communication approach can simplify integration with existing vehicle control systems and facilitate over-the-air updates, remote diagnostics, and real-time data exchange with external devices such as smartphones or onboard vehicle control units.

In a further example embodiment, at least one sensor is mounted on or integrated into the compressor housing or manifold housing and is in signal communication with the control unit. The control unit may be configured to analyze and process the sensor data and/or to transmit the data to the user interface.

The sensor mounted on or integrated into the compressor housing or manifold housing may be any device capable of detecting and transmitting data relevant to the operation of the tire pressure management system. For example, the sensor may be a pressure sensor that continuously monitors the tire pressure, a temperature sensor that detects heat buildup within the compressor or tire, or an accelerometer that measures vibrations and movement of the wheel assembly. These sensors enable precise real-time data collection, allowing the control unit to optimize compressor performance, detect potential failures, and ensure the tire pressure is adjusted according to changing operating conditions.

The compressor housing may refer to an enclosure that contains and protects the electrically powered compressor and its associated components. It may be designed to be compact, lightweight, and durable, ensuring reliable operation within the rim structure while withstanding mechanical stress, vibrations, and environmental factors such as dust, moisture, and temperature fluctuations. The housing may be made from metal alloys, high-strength plastics, or composite materials such as carbon fiber to optimize weight, thermal dissipation, and structural integrity.

Additionally, the compressor housing may feature integrated mounting points for secure attachment to the rim well or another part of the wheel assembly. It may also include sealed openings for airflow, electrical connections, and signal transmission, as well as internal compartments to accommodate components such as the motor, valves, and sensors.

As already explained above, the compressor or the compressor housing may be integrated into the manifold.

In the present application, the term “sensor” may be equivalent to a sensor system, or alternatively, a sensor system may encompass or comprise one or more individual sensors. For example, the sensor system may include one or more sensors, such as a camera, an inertial measurement unit (IMU), a suspension position sensor, a position sensor, such as a GPS-Sensor, a tire pressure sensor, a load sensor, a temperature sensor, and/or a vibration sensor. The sensors within the sensor system may be positioned at different locations on the vehicle, meaning they can be spatially separated while still being considered part of the same sensor system. For instance, the camera may be mounted on the front bumper to detect road conditions, while the tire pressure sensor may be installed in the rim well to measure the internal tire pressure.

Regarding the analysis and processing of sensor data, the control unit may utilize different algorithms depending on the requirements and the type of sensor data being processed. For example, machine learning algorithms or other AI-based algorithms may be employed to recognize patterns, predict anomalies, and optimize compressor operation based on historical and real-time data.

The control unit may process and transmit sensor data to the user interface, allowing the user to monitor tire pressure, temperature, or other relevant parameters in real time. This enables the system to provide visual, auditory, or haptic feedback, alerting the user to abnormal conditions, necessary adjustments, or maintenance requirements.

In a further example embodiment, the tire pressure management system may comprise a reservoir integrated within the tire casing, which is fluidly isolated from the internal fluid volume of the tire casing. The reservoir is operatively coupled to the compressor, allowing it to store compressed fluid and facilitate rapid pressure adjustments when needed. This design enables quicker inflation or deflation without requiring continuous compressor operation, improving efficiency and response time.

Being fluidly isolated from the internal fluid volume of the tire casing may mean that the reservoir and the main air chamber of the tire do not share a continuous airflow path under normal operating conditions. Instead, the reservoir can be a separate, enclosed chamber that can store compressed fluid independently. This isolation allows for precise control over the release and intake of compressed air, reducing pressure fluctuations and enabling optimized performance based on driving conditions.

The reservoir may be fluidly connected to the outlet of the compressor via a hose, enabling efficient transfer and storage of compressed air for later use. However, other connection types may also be considered, such as rigid piping, flexible ducts, or integrated air channels within the rim, depending on the specific design requirements and space constraints.

To regulate the airflow, the reservoir includes an outlet valve designed to release fluid into the tire casing as needed. By controlling the amount and timing of air release, this mechanism ensures precise pressure adjustments, maintaining stability and preventing abrupt fluctuations. The integration of the reservoir allows for rapid pressure modifications without requiring continuous compressor operation.

In this context, the outlet valve may comprise an electric controlled valve being in signal communication with the control unit. The control unit may be configured to open the outlet valve in response to user input via the user interface or automatically based on sensor measurements.

For example, a user input may involve selecting a desired tire pressure on a touchscreen display, pressing a physical button, or issuing a voice command, prompting the system to release air from the reservoir into the tire casing. Alternatively, a sensor measurement, such as a detected decrease in tire pressure due to temperature changes, may trigger the control unit to automatically open the outlet valve to maintain optimal pressure without user intervention.

In an exemplary embodiment, the reservoir may extend over a partial region of the circumference of the rim well of the rim and is located on the side of the rim well opposite the compressor. In this context, the side opposite the compressor may refer to a position on the rim well that is diametrically opposed to the compressor. More precisely, if the attachment point of the compressor and the attachment point of the reservoir on the rim or rim well are defined and connected by an imaginary straight line, this line would represent the diameter of the rim.

In an alternative embodiment, the reservoir can be configured to extend around the entire circumference of the rim well, forming a continuous structure along the contour of the rim well.

However, the application is not limited to the aforementioned configurations, and other placement options for the reservoir are also possible. For example, the reservoir could be positioned within structural cavities of the rim or integrated into spoke-like structures,

The reservoir may be made from a variety of materials, depending on design requirements such as flexibility, weight, durability, and resistance to environmental factors. It can be constructed as a rigid structure, a flexible component, or a combination of both.

A rigid reservoir may be made of lightweight and durable materials such as aluminum or titanium. In an example embodiment, the reservoir is made of carbon fiber, which offers an ideal combination of high strength, low weight, and excellent resistance to pressure fluctuations. Alternatively, reinforced plastics like polycarbonate (PC) or glass-fiber-reinforced polyamide (PA-GF) can be used to reduce weight while maintaining structural integrity and impact resistance.

In certain embodiments, the reservoir may also be integrated directly into the rim, which is typically made of aluminum, thereby optimizing space and weight distribution.

A flexible reservoir may be made from rubber-based or elastomeric materials such as silicone, EPDM (ethylene propylene diene monomer), or thermoplastic polyurethane (TPU). These materials allow for compression and expansion, enabling the reservoir to adjust its volume dynamically based on pressure demands. This is particularly advantageous in systems where space constraints or adaptive air storage are required.

In some cases, a hybrid design may be used, where a rigid outer shell provides protection and structural support, while an internal flexible membrane or bladder (e.g., made of butyl rubber or Polytetrafluoroethylene [PTFE]) facilitates controlled air storage and release. The choice of material depends on factors such as operating pressure, thermal stability, resistance to vibrations, and overall weight considerations.

In a further exemplary embodiment, the application relates to a motorcycle comprising a tire pressure management system according to any of the preceding embodiments. In this regard, the tire pressure management system can be configured for managing the front or rear tire pressure.

Motorcycles often operate under variable load conditions, such as changes in rider weight, passenger load, or luggage, which can significantly impact handling and stability. By integrating a tire pressure management system, the motorcycle can dynamically adjust tire pressure to optimize grip, comfort, and fuel efficiency. The system may be particularly beneficial for off-road, race or touring motorcycles, where tire pressure adjustments are frequently needed to adapt to changing terrains.

Alternatively, the motorcycle may comprise two tire pressure management systems according to any of the embodiments, wherein both systems can be controlled by a user via a single user interface. This setup allows the rider to independently or simultaneously modify the pressure in the front and rear tires, optimizing handling, stability, and traction based on riding conditions. For instance, during off-road riding, the system may allow the user to lower the rear tire pressure for better grip while keeping the front tire at a higher pressure for improved steering precision. Additionally, the integration of both systems into a single user interface simplifies operation, ensuring intuitive control through touchscreen commands, physical buttons, or voice input, depending on the specific implementation.

In a further example embodiment, the application relates to a method for controlling tire pressure in a motorcycle tire. The method may comprise the following steps:

First, a tire pressure management system according to any of the preceding embodiments and/or a motorcycle equipped with such a system may be provided. Then, a desired pressure value for the front or rear tire may be inputted via a user interface, based on which the control unit adjusts the pressure accordingly. Alternatively or additionally, sensor data may be detected via sensors, transmitted to the control unit, and used to automatically adjust the tire pressure based on the detected parameters.

The tire pressure control process may take place regardless of whether the motorcycle is stationary or in motion, allowing for real-time adjustments while riding or when the vehicle is at rest. Additionally, the system may function independently of the rider's presence, meaning that tire pressure adjustments can be performed whether a user is seated on the motorcycle or not. This ensures flexibility in operation, enabling pressure modifications before, during, or after a ride based on the rider's preferences or automatically in response to detected conditions.

The skilled person will recognize that the advantages, technical effects and embodiments discussed in connection with the tire pressure management system apply analogously to the method for controlling tire pressure in a motorcycle tire. It is also apparent that all described embodiments of the method can be correspondingly formulated in an analogous manner within the system.

In a further aspect, the application relates to a further tire pressure management system for a vehicle.

The system may comprise a tire cavity having a working volume configured to contain an air volume for maintaining an operating tire pressure. It may further comprise a means located within the tire cavity for increasing and decreasing the working volume of the tire cavity to adjust the internal tire pressure. A control unit may be configured to regulate the means for increasing and decreasing the working volume of the tire cavity to achieve a target pressure. Additionally, a power supply system may be configured to provide power to the control unit and the means.

By actively adjusting the working volume of the tire cavity, the system enables real-time adaptation of tire pressure to varying driving conditions, enhancing traction, stability, and fuel efficiency. Furthermore, the ability to dynamically regulate internal pressure reduces tire wear and improves ride comfort by optimizing the contact surface between the tire and the road.

For example, if a vehicle transitions from a paved road to a sandy or muddy surface, the system can detect reduced traction through the vehicle's control unit or external sensors. The control unit may then regulate the means for increasing the working volume of the tire cavity, thereby reducing the internal tire pressure to improve grip and stability. Once the vehicle returns to a firmer surface, the system can decrease the working volume, increasing the tire pressure back to an optimal level for fuel efficiency and handling. This automatic adjustment ensures that the vehicle maintains optimal performance across different terrains without requiring manual intervention.

In an example embodiment, the means may comprise a cylinder with a sealed piston configured to extend and retract to modify the working volume of the tire cavity, thereby adjusting the internal tire pressure, wherein the piston is operably coupled to an electric motor powered by the power supply system and the control unit.

The retraction of the piston increases the working volume of the tire cavity, effectively reducing the internal pressure, while extension decreases the working volume, raising the pressure as needed. This allows for precise and dynamic pressure adjustments in response to real-time driving conditions, ensuring optimal traction, stability, and efficiency. By utilizing an electric motor for actuation, the system enables quick and controlled pressure regulation without requiring external air compressors or complex pneumatic systems, making it particularly compact and energy-efficient. Additionally, the integration of the control unit allows for automated or user-defined adjustments, ensuring that the system responds dynamically to factors such as road conditions, load changes, or predefined driving modes.

In alternative embodiment, the means may comprise one or more of the following: bladders, membranes, solenoids, motors, or other actuators, all operably connected to the power supply system and the control unit and configured to modify the working volume of the tire cavity. These components enable precise and responsive adjustments to the internal tire pressure by expanding or contracting the working volume as needed. By integrating different actuation mechanisms, the system can adapt to various vehicle requirements and operating conditions while ensuring efficient and reliable pressure regulation.

In a further example embodiment, a method for controlling the tire pressure of a vehicle is provided, wherein the vehicle comprises a tire cavity with a working volume. The method may comprise the steps of adjusting the working volume of the tire cavity using a means located within the tire cavity to selectively increase or decrease the internal tire pressure, regulating the means for adjusting the working volume via a control unit to achieve a target tire pressure, and supplying electrical power to both the control unit and the means for adjusting the working volume through a power supply system.

The skilled person will recognize that the advantages, technical effects and embodiments discussed in connection with the tire pressure management system apply analogously to the method for controlling tire pressure of a vehicle. It is also apparent that all described embodiments of the method can be correspondingly formulated in an analogous manner within the system.

Furthermore, similar to the previous aspects, a vehicle, particularly a motorcycle, may also be provided, incorporating either a single tire management system or one for each tire, which can be manually controlled via a user interface or automatically respond to changes through sensors.

In further aspects, the application relates to different methods for controlling or dynamically adjusting the tire pressure of a tire in a vehicle comprising a tire pressure management system. The tire pressure management system may comprise the features of any of the embodiments described above.

The tire pressure management system may comprise an electrically powered compressor mounted on a rim, a valve unit, a power supply system for providing electrical power to the compressor and a control unit for controlling the compressor and the valve unit.

A first disclosed method may comprise the following steps:

First, multiple tire pressure values may be stored in a database using a data processing unit that includes at least a memory and a processor. These tire pressure values can be associated with predefined riding modes, such as off-road, street, sport, or eco. Subsequently, a target tire pressure may be determined based on the user's manual selection of a riding mode, wherein the target tire pressure may correspond to the tire pressure value assigned to the selected mode.

Next, the current tire pressure can be detected using a sensor system, and the measured value may be transmitted to the data processing unit. The data processing unit may then compare the current tire pressure with the target tire pressure. If a deviation is detected or the current tire pressure exceeds a predefined threshold, an adjustment can be made. This adjustment may involve either activating the compressor to compress a fluid and increase the tire pressure until the target value is reached or activating the valve unit to release fluid from the tire into the external atmosphere to decrease the tire pressure accordingly.

The main advantage of this method is its ability to dynamically adjust tire pressure based on predefined riding modes, improving performance, safety, and efficiency. By automatically adapting the pressure for different conditions such as off-road, street, sport, or eco, the system enhances grip, stability, and maneuverability while reducing rolling resistance where needed.

A second disclosed method may comprise the following steps:

First, a plurality of tire pressure values may be stored in a database using a data processing unit comprising at least a memory and a processor, wherein the tire pressure values may be associated with weight parameters, including the weight of the rider, luggage, and/or passengers. A target tire pressure may then be determined based on either a manual input of the rider's, luggage's, and/or passengers'weight by a user or an automatic determination of the rider's, luggage's, and/or passengers'weight using a sensor system. The target tire pressure may correspond to the tire pressure value associated with the manually inputted or automatically determined weight.

Next, the current tire pressure can be detected using a sensor system, and the measured value may be transmitted to the data processing unit. The data processing unit may then compare the current tire pressure with the target tire pressure. If a deviation is detected or the current tire pressure exceeds a predefined threshold, an adjustment can be made. This adjustment may involve either activating the compressor to compress a fluid and increase the tire pressure until the target value is reached or activating the valve unit to release fluid from the tire into the external atmosphere to decrease the tire pressure accordingly.

The advantage of this method lies in its ability to dynamically adjust tire pressure based on the actual weight of the rider, luggage, and/or passengers, ensuring optimal performance, safety, and efficiency. By automatically adapting the pressure to varying load conditions, the system prevents rolling resistance, tire wear, and instability while maintaining optimal grip, ride comfort, and braking performance in real-time.

For example, if a motorcycle is loaded with additional luggage and a passenger, the increased weight exerts greater force on the tires, causing compression and a larger contact patch with the road. Without adjustment, this could lead to higher rolling resistance, increased tire wear, and reduced handling precision. The system detects the additional load using a sensor, determines the necessary compensation, and increases the tire pressure accordingly. If the rider later removes the luggage and continues alone, the system detects the weight reduction and lowers the tire pressure to prevent stiffness, ensuring a smoother ride and maintaining optimal traction.

A third disclosed method may comprise the following steps:

First, road and chassis conditions may be detected using a sensor system, wherein the detected parameters may be selected from suspension movement and compression patterns averaged over time, chassis vibration or structural displacement data, road condition data obtained from a database based on GPS location, and historical onboard road condition data stored in memory and correlated with GPS positioning. Based on the detected road and chassis conditions, a target tire pressure may be determined using a data processing unit comprising a processor and a memory.

Next, the current tire pressure can be detected using a sensor system, and the measured value may be transmitted to the data processing unit. The data processing unit may then compare the current tire pressure with the target tire pressure. If a deviation is detected or the current tire pressure exceeds a predefined threshold, an adjustment can be made. This adjustment may involve either activating the compressor to compress a fluid and increase the tire pressure until the target value is reached or activating the valve unit to release fluid from the tire into the external atmosphere to decrease the tire pressure accordingly.

The advantage of this method is that it enables dynamic tire pressure adjustments based on real-time road and chassis conditions rather than relying on predefined values. By continuously analyzing suspension movement, vibration data, and road conditions retrieved from a GPS-based database or historical records, the system can proactively modify the target tire pressure to optimize stability, comfort, and efficiency. This ensures that the tire pressure adapts to changing terrains, reducing wear, improving traction, and enhancing overall vehicle performance without requiring manual adjustments.

For example, when transitioning from a paved highway to a gravel road, the system retrieves road surface information from a database and analyzes suspension movement and vibration patterns to assess terrain changes. Based on this analysis, the control unit may determine that a lower tire pressure is required for improved traction and activate the valve unit to release air until the target pressure is reached.

Suspension movement may refer to the vertical displacement of the wheel relative to the vehicle chassis, influenced by road conditions and driving dynamics. By averaging compression and rebound patterns over time, the system can identify terrain characteristics and detect anomalies, such as persistent rough surfaces or oscillations. For example, if a motorcycle repeatedly encounters deep potholes, the system may adjust the tire pressure to enhance shock absorption and improve ride comfort.

Chassis vibrations are oscillations transmitted through the vehicle's frame, influenced by factors such as road irregularities, speed, and tire pressure. Structural displacement data helps assess how different forces affect vehicle stability and ride quality. For instance, if increased vibrations are detected at high speeds on a rough road, the system may recommend lowering tire pressure to improve traction and damping.

A database containing road condition data can provide real-time insights into surface types, elevation changes, and known hazards. By linking GPS coordinates with pre-recorded road surface classifications, the system can anticipate necessary tire pressure adjustments before the vehicle reaches a specific terrain. For example, if the GPS indicates an upcoming gravel road, the system may proactively reduce tire pressure to optimize grip and handling.

Vehicles can store and analyze past road condition data to refine their tire pressure management strategy over time. By correlating previously recorded road surface characteristics with GPS locations, the system can improve predictive adjustments for frequently traveled routes. For example, if a rider frequently transitions from city streets to off-road trails, the system may learn to automatically adjust tire pressure at specific locations based on past experiences.

A current tire pressure may refer to a measured value representing the internal air pressure within a vehicle tire at a given point in time. The term “current” in this context may refer to the pressure value that is valid or present at the moment of detection or processing. It may reflect the actual, instantaneous condition of the tire and may vary in response to factors such as temperature, load, or driving conditions.

The disclosed methods above are particularly suitable for motorcycles but are not limited to such applications.

The control unit of the tire pressure management system may be in data communication with the data processing unit. It may also be provided that the data processing unit is an integral part of the control unit, thereby making it a component of the tire pressure management system itself. The database storing the tire pressure values may be implemented in the memory of the data processing unit. However, it may also be provided that the database is hosted in a cloud or on a server, with which the data processing unit is in data communication, retrieving the relevant tire pressure values via IP-based communication. It is understood that, in this context, the data processing unit includes a communication module to facilitate such data exchange.

As mentioned above, specific tire pressure values may assigned to different predefined riding modes, ensuring optimal performance for various conditions. In other words, specific tire pressure values may be linked to predefined riding modes to optimize tire performance based on varying road conditions and driving requirements. Off-road mode may have a lower tire pressure to improve traction on rough terrain, while street mode could use a higher pressure for better stability and fuel efficiency on paved roads. Sport mode might be optimized for high-performance handling and grip, whereas eco mode may prioritize minimal rolling resistance to enhance fuel economy or battery efficiency. When a rider selects a riding mode, the system retrieves the corresponding tire pressure value and adjusts the tire pressure accordingly.

The off-road riding mode can be associated with a target tire pressure between about 12 psi and about 18 psi to enhance traction on loose surfaces such as dirt, sand, or gravel. This lower pressure increases the tire's contact patch with the ground, enhancing grip and reducing the likelihood of sinking into soft terrain. Additionally, it can improve shock absorption by allowing the tire to deform more easily over obstacles, contributing to a smoother ride and reducing strain on the suspension system. To prevent tire deformation or rim damage, the system may also monitor wheel speed, load distribution, and temperature to ensure safe operation under off-road conditions.

The sport riding mode can be associated with a target tire pressure between about 33 psi and about 42 psi to improve handling, cornering stability, and responsiveness on paved roads at high speeds. A higher tire pressure in this mode reduces sidewall flex, resulting in more precise steering input and improved road feedback. It also minimizes rolling resistance, enhancing acceleration and efficiency while maintaining stability during aggressive maneuvers.

Further, the street riding mode can be associated with a target tire pressure between about 29 psi and about 36 psi to ensure a balance between comfort, tire wear, and fuel efficiency for general road use. This pressure range allows for adequate sidewall flexibility to absorb road irregularities while maintaining stability and traction. It also helps distribute contact forces evenly across the tire tread, reducing uneven wear and extending tire lifespan. Additionally, the optimized rolling resistance contributes to improved fuel efficiency or battery range while ensuring consistent handling and braking performance under typical riding conditions.

The eco riding mode is associated with a target tire pressure between about 36 psi and about 44 psi to minimize rolling resistance and improve fuel efficiency. The higher pressure reduces tire deformation, decreasing energy loss and enhancing overall vehicle efficiency. This mode is particularly beneficial for long-distance travel or urban commuting, where maintaining a lower rolling resistance can extend fuel economy or battery range. Additionally, the optimized tire pressure in eco mode helps reduce heat buildup and tread wear, contributing to an extended tire lifespan and lower maintenance costs.

The target tire pressure can for example be based on the manual selection of a riding mode by a user. In this regard, the target tire pressure corresponds to the tire pressure value associated with the selected riding mode. In other words, the target tire pressure is determined based on the riding mode manually selected by the user. When a specific riding mode is chosen, the system retrieves the corresponding predefined tire pressure value associated with that mode. This allows the system to apply a pressure setting that aligns with the intended use of the vehicle, whether for improved grip on rough terrain, enhanced fuel efficiency, or better handling on paved roads. By linking tire pressure to riding modes, the system ensures that adjustments are made consistently and in accordance with predefined parameters.

Moreover, the sensor system can be configured to measure the current tire pressure and transmit the corresponding value to the data processing unit. It is apparent that the sensor system is in data or signal communication with the data processing unit and/or the control unit. The sensor system may particularly include a tire pressure sensor designed to detect the current tire pressure in real-time.

If the current tire pressure differs from the target tire pressure or surpasses a predefined limit, the system adjusts the pressure accordingly. This adjustment is carried out either by activating the compressor to pressurize a fluid and raise the tire pressure until the target value is reached or by engaging the valve unit to release fluid from the tire into the surrounding atmosphere, thereby lowering the pressure to the desired level.

In some example embodiments, particularly in embodiments of the second and third methods, tire pressure values stored in a database using a data processing unit may be associated with predefined riding modes, such as off-road, street, sport, or eco, as already explained in the first method. Subsequently, the target tire pressure may be modified based on a manual selection of a riding mode by the user, wherein the target tire pressure corresponds to the tire pressure value assigned to the selected riding mode.

In some example embodiments, particularly in embodiments of the first and third methods, tire pressure values stored in a database using a data processing unit may be associated with weight parameters, including the weight of the rider, luggage, and/or passengers, as already explained in the second method. In this case, the method may further include modifying the target tire pressure based on either a manual input of these weight parameters by the user or an automatic determination of the rider's, luggage's, and/or passengers' weight using the sensor system.

This enables the system to dynamically adjust the tire pressure to accommodate varying load conditions while simultaneously considering the selected riding mode and/or road and chassis conditions. By combining load-dependent adjustments with mode-specific pressure settings and/or road and chassis conditions, the system ensures optimal performance, stability, and comfort across different riding scenarios.

For example, if a rider selects off-road mode while carrying additional luggage, the system may automatically reduce the tire pressure to improve traction on uneven terrain but compensate for the added weight by ensuring that the tires do not become overly compressed, which could otherwise reduce stability and increase rolling resistance. This compensation may involve setting a slightly higher pressure than the standard off-road value to maintain sufficient structural integrity while still allowing for optimal grip. Similarly, if eco mode is selected and the system detects a passenger, it may increase the tire pressure to reduce rolling resistance and maintain efficiency while simultaneously preventing tire deformation caused by the additional load. This ensures that the tire maintains an optimal contact patch with the road, balancing energy efficiency with ride stability and comfort.

Generally, the data processing unit may comprise a user interface or be in signal communication with a user interface configured to receive input from a user, wherein the user interface is used for the manual selection of a riding mode and/or the manual input of the rider's, luggage's, and/or passengers'weight. The user interface may be the one described above in relation to the tire pressure management system.

In a some example embodiment, particularly in embodiments of the first and second methods, the method may further comprise detecting road and chassis conditions using the sensor system, wherein the detected parameters are selected from the group consisting of suspension movement and compression patterns averaged over time, chassis vibration or structural displacement data, road condition data obtained from a database based on GPS location, and historical onboard road condition data stored in memory and correlated with GPS positioning, as already explained in the third method. The data processing unit may analyze these parameters to assess surface irregularities, driving conditions, and structural loads affecting the vehicle. Based on the detected road and chassis conditions, the method may further include modifying the target tire pressure to optimize stability, comfort, and performance by dynamically adjusting to changing terrain and structural feedback.

The aforementioned methods or embodiments of the methods are primarily based on the principle of determining a target pressure and adjusting the current tire pressure accordingly.

The following describes a method for determining an optimal target tire pressure for a vehicle tire. This method can be implemented independently or in combination with one of the three previously mentioned methods, as well as with any of their respective embodiments.

The method for determining an optimal target tire pressure of a tire in a vehicle may comprise detecting, using the sensor system, at least one operating parameter selected from the group consisting of suspension travel data, including compression and rebound speed, suspension compression level, road conditions or surface properties, and motion and dynamic state data, including acceleration, angular velocity, and orientation,. The detected operating parameters may then be stored and analyzed using the data processing unit to evaluate their impact on tire performance and riding conditions.

Based on at least one detected operating parameter, the method may further include determining the target tire pressure to dynamically adjust for changing road conditions, vehicle dynamics, and load distribution, ensuring optimal stability, traction, and ride comfort.

If the method for determining an optimal target tire pressure is combined with the three aforementioned methods, the previously determined target tire pressure can be modified based on at least one detected operating parameter. Modifying the target tire pressure considering the operating parameter ensures that the system determines an even better optimized tire pressure for the vehicle, dynamically adapting to real-time conditions for improved stability, traction, and ride comfort.

For example, when transitioning from a smooth highway to a rough rural road, the method detects increased suspension compression and rebound speed through a suspension position sensor, while a vibration sensor registers higher chassis vibrations. The data processing unit analyzes these parameters and determines that a lower tire pressure would improve traction and ride comfort on the uneven terrain.

The sensor system may comprise one or more sensors selected from the group consisting of a camera configured to detect road conditions or surface properties, an inertial measurement unit (IMU) configured to capture acceleration, angular velocity, and orientation changes of the vehicle, and a suspension position sensor configured to measure suspension compression level and travel data. Additionally, the system may include a tire pressure sensor configured to detect the current tire pressure in real-time, a load sensor configured to determine the weight of the rider, luggage, and/or passengers, and a vibration sensor configured to detect chassis vibrations and structural displacements.

In a further aspect, the application relates to a method for dynamically adjusting tire pressure to enhance vehicle stability and safety, wherein the vehicle comprises a tire pressure management system. The tire pressure management system may comprise the features of any of the embodiments described above.

The tire pressure management system may comprise an electrically powered compressor mounted on a rim, a valve unit, a power supply system for providing electrical power to the compressor and a control unit for controlling the compressor and the valve unit.

The method may comprise the following steps:

First, one or more operating parameters may be detected using a sensor system, wherein these parameters may include the activation state of an anti-lock braking system (ABS) as well as road conditions, surface properties, and road characteristics such as curvature, incline, and surface irregularities. The detected parameters may then be analyzed using a data processing unit comprising a memory and a processor to determine a target tire pressure that enhances stability, braking performance, and accident prevention in critical driving conditions.

Next, the current tire pressure can be detected using a sensor system, and the measured value may be transmitted to the data processing unit. The data processing unit may then compare the current tire pressure with the target tire pressure. If a deviation from the target tire pressure is detected or the current tire pressure exceeds a predefined threshold, an adjustment can be made. This adjustment may involve either activating the compressor to compress a fluid and increase the tire pressure until the target value is reached or activating the valve unit to release fluid from the tire into the external atmosphere to decrease the tire pressure accordingly until the target value is reached.

By dynamically adjusting the tire pressure based on real-time operating parameters, the method enhances vehicle stability, braking performance, and overall driving safety. This ensures optimal traction and load distribution under varying road conditions, reducing the risk of skidding, loss of control, or inefficient tire wear.

For example, while descending a steep mountain road with sharp curves, the system detects frequent activation of the anti-lock braking system (ABS) and identifies road curvature and incline using GPS-based road data. The data processing unit evaluates these parameters and determines that a slightly increased tire pressure would improve braking efficiency and reduce rolling resistance for better control. If the current tire pressure is below the calculated target value, the system activates the electrically powered compressor to increase pressure accordingly.

This method is particularly well-suited for motorcycles, without limiting the scope of the application to such vehicles.

Another example of the method in practice can be seen in a motorcycle transitioning from a dry, paved road to a gravel path. As the motorcycle moves onto the rougher terrain, the sensor system may detect changes in road surface properties, increased vibration levels, and reduced traction. Additionally, if the rider applies the brakes, the activation of the anti-lock braking system (ABS) may indicate a need for improved tire grip.

Based on these detected parameters, the data processing unit may determine that a lower tire pressure would enhance traction and stability on the gravel surface. The system may then compare the current tire pressure with the target pressure and, if necessary, adjust it by activating the valve unit to release a controlled amount of air. When the motorcycle returns to a paved road, the system may detect the smoother surface and increase the tire pressure by activating the compressor, ensuring improved stability, braking performance, and fuel efficiency.

This dynamic adjustment of tire pressure allows for optimized handling, increased safety, and reduced tire wear, demonstrating the advantages of the method under varying real-world driving conditions.

Analyzing, in the context of this method, may refer to processing and evaluating the detected parameters to extract meaningful insights for tire pressure adjustment. This may include assessing how long and how frequently the ABS is triggered, identifying patterns in road surface changes, measuring variations in suspension compression, and correlating vehicle dynamics such as acceleration, braking intensity, and vibration levels. By interpreting these data points, the system can determine whether an adjustment to the tire pressure is necessary to enhance stability, traction, and overall driving performance.

In this context, the sensor system may comprise one or more sensors selected from the group consisting of a communication interface configured to receive the activation state of the anti-lock braking system (ABS) from a vehicle control unit and a road surface condition sensor, which may include a camera-based system, infrared, or LiDAR technology for detecting surface properties and irregularities.

A communication interface, in the context of this method, may refer to a hardware and/or software-based module that enables data exchange between the tire pressure management system and other vehicle control units. It may facilitate the reception and transmission of signals using wired or wireless communication protocols such as CAN (Controller Area Network), LIN (Local Interconnect Network), or IP-based communication. This interface allows the method and/or the tire pressure management system to receive real-time data, such as the activation state of the anti-lock braking system (ABS), throttle position, or traction control status, which can be used to assess driving conditions and dynamically adjust the tire pressure accordingly

In a further aspect, the application relates to a system for automated tire sealing in a vehicle.

The system may comprise a sealant reservoir integrated within the tire casing, designed to store a sealing fluid in a deployable state. A sensor system may be included to detect a pressure drop or leakage within the tire, allowing for real-time identification of potential punctures or air loss. Upon detection of a pressure drop, a sealant shooter mechanism, which is operatively coupled to the sealant reservoir, may inject a predefined amount of sealing fluid into the inner tire cavity to seal the affected area. The system may further include a dispersion mechanism that utilizes the natural rotation of the tire to evenly distribute the sealing fluid across the inner surface, ensuring effective sealing and maintaining tire integrity while in motion.

The automated tire sealing system enhances vehicle safety and reliability by immediately responding to pressure drops or leaks, reducing the risk of sudden deflation while driving. By integrating a sealant reservoir and an automatic injection mechanism, the system eliminates the need for manual intervention. Additionally, the dispersion mechanism leverages the tire's natural rotation to evenly distribute the sealing fluid.

The sealant reservoir may be positioned along the rim well of a rim of the tire and is fluidly isolated from the tire's internal air volume until activation.

The sealant shooter mechanism may comprise a pressurized injection system, including a micro-pump or a CO₂ cartridge-based expulsion unit. A micro-pump may refer to a compact electrically powered pump that actively injects a predefined amount of sealing fluid into the inner tire cavity when a pressure drop is detected. In contrast, a CO₂ cartridge-based expulsion unit utilizes a pressurized CO₂ canister to rapidly force the sealant from the reservoir into the affected area without requiring an external power source. This design ensures immediate and controlled deployment of the sealing fluid, allowing for quick puncture sealing and pressure stabilization. By integrating these pressurized systems, the mechanism enhances the efficiency and reliability of the tire sealing process, reducing the risk of further air loss and maintaining optimal tire performance.

The sensor system may comprise a tire pressure sensor configured to detect the current tire pressure in real-time. This sensor can continuously monitor pressure levels within the tire and transmits the measured values to the data processing unit. By providing real-time data, the sensor enables the system to detect pressure deviations, leaks, or sudden drops, allowing for timely adjustments or sealing actions. This ensures optimal tire performance, enhances driving safety, and minimizes the risk of tire failure due to unnoticed pressure loss.

In an example embodiment the system may further comprise an automated valve control unit that regulates the injection timing and volume of the sealant fluid based on the severity of the pressure drop. The automated valve control unit may refer to an electronically or mechanically controlled valve mechanism that adjusts the flow rate and duration of sealant injection, ensuring that minor leaks receive a smaller amount of sealant while more severe pressure drops trigger a larger and faster injection.

The sealant fluid may include a self-curing polymer-based composition capable of sealing punctures up to a predefined size threshold. A self-curing polymer-based composition refers to a fluid material that undergoes a chemical or physical transformation upon exposure to air or pressure changes, forming a solid or semi-solid seal over the punctured area. The predefined size threshold determines the maximum diameter of punctures that the sealant can effectively close, ensuring reliable sealing performance for common tire damages while maintaining flexibility and durability within the tire cavity.

An example of a self-curing polymer-based composition for sealant fluid may be polyisobutylene (PIB)-based sealant. Polyisobutylene is a viscoelastic synthetic rubber that remains flexible and forms an airtight seal when exposed to air. When incorporated into a sealant formulation, it can be combined with curing agents and reactive additives to solidify upon contact with a punctured surface, effectively sealing holes up to a predefined size threshold. This ensures durability, elasticity, and adhesion, allowing the sealant to maintain tire integrity while preventing further air loss.

In a further example embodiment, the system may comprise a control unit that communicates with a tire pressure management system to provide real-time feedback on tire status and sealing effectiveness. The tire pressure management system may comprise the features of any of the embodiments described above.

For example, if the tire pressure management system detects a gradual pressure loss over time, it can assess whether the automated sealing system has already deployed sealant and whether the pressure has stabilized. If the pressure remains within an acceptable range after the sealing process, the control unit can confirm the effectiveness of the seal and adjust the tire pressure if necessary. However, if the pressure continues to drop despite sealant application, the system may trigger an alert, informing the driver that the puncture is too severe for automated sealing and that further manual intervention is required.

In a further aspect, the application relates to an electric tire heating system for a vehicle.

In many types of vehicles, particularly motorcycles, cold tires can significantly affect driving safety and performance. Traditional tire heating methods—such as external wrap-around heating blankets—are cumbersome and limited to stationary use. There remains a need for an integrated tire heating solution that allows real-time temperature regulation during vehicle operation.

To overcome this issue, the system may comprise a heating element that may be mounted in a tire casing or within a tire cavity of a wheel assembly, the heating element being configured to generate heat to raise the temperature of a tire. The system may further comprise a power supply system that can be configured to provide electrical power to the heating element, and at least one temperature sensor that may be configured to detect the temperature of the tire, the tire cavity, and/or the tire tread. A control unit may be located in or on the wheel assembly, the control unit being in signal communication with a user interface, the heating element and/or the at least one temperature sensor, and comprising a microprocessor which may be configured to receive user commands via the user interface, to control the operation of the heating element based on user commands and/or temperature sensor data, and to transmit data to the user interface.

The system described above enables targeted heating of a vehicle tire during operation, which produces several technical effects. By increasing the temperature of the tire in a controlled manner, the system improves tire grip, driving stability, and safety, particularly in cold ambient conditions or during the initial phase of a ride. Heating the tire reduces the warm-up time required to reach optimal performance temperatures, which results in better traction and more predictable handling characteristics.

Furthermore, the system allows real-time adaptation to user preferences or environmental conditions, either manually or automatically, which improves rider comfort and energy efficiency. The presence of temperature sensors and a microprocessor-based control unit enables closed-loop regulation and automation, which reduces the risk of overheating and ensures operation within safe thermal limits. The ability to store and process temperature data also allows integration with smart control strategies and connectivity features, supporting predictive or remote-controlled operation.

The heating element may refer to a component configured to convert electrical energy into thermal energy. It may be implemented in various forms, including but not limited to a resistive wire, a printed conductive film, or a flexible heating mat. The heating element may be adhered to the inner surface of the tire or integrated directly into the tire structure during manufacture.

In an example embodiment, the heating element is arranged on the inner liner of the tire, either bonded using a thermally stable adhesive or vulcanized into the tire compound. This positioning allows efficient thermal conduction to the tire carcass and tread region while minimizing exposure to external influences and mechanical stress during rotation.

By actively increasing the temperature of the tire material, the heating element improves the elasticity and friction characteristics of the tread surface, which in turn leads to better traction, reduced warm-up times, and enhanced overall vehicle safety—particularly under cold ambient conditions. The direct application of heat to the tire structure ensures rapid response and localized control, allowing the system to reach and maintain defined temperature ranges with high precision.

The integration of such a heating element into the tire or its immediate surroundings yields further technical effects, including energy efficiency, spatial compactness, and compatibility with rotating wheel assemblies. Due to its low mass and flexible form factor, the heating element does not significantly affect the dynamic balance or inertia of the wheel, which is particularly important in high-speed applications such as motorcycles.

In one concrete exemplary embodiment, the heating element may comprise a helically wound resistive wire made of nickel—chromium (NiCr) alloy, embedded in a silicone-insulated carrier layer. The layer is bonded to the inner surface of the tire using a temperature-resistant adhesive film. The system may be equipped with one or more temperature sensors for feedback control, as described in other sections of this disclosure.

The tire cavity may define the internal volume enclosed by the mounted tire and the rim, typically filled with pressurized air. This cavity serves as the primary location for heat distribution and temperature measurement.

In an example embodiment, the vehicle is a motorcycle. Motorcycles benefit in particular from the system, as cold tires can significantly affect handling and safety. The compact design of the system allows integration into limited installation spaces, while a handlebar-mounted user interface enables convenient control by the rider.

The power supply system may be implemented in various forms and can be constructed similarly to the power supply architecture described in the previously disclosed tire pressure management system, wherein, instead of supplying electrical energy to a compressor, the system is configured to power a heating element.

In one embodiment, the system comprises a transformer-based inductive power supply system, allowing wireless energy transmission between a stationary component (e.g., an axle-mounted primary coil) and a rotating component (e.g., a hub-mounted secondary coil). Alternatively, the power supply system may include a slip ring assembly, which provides electrical contact between stationary and rotating parts of the wheel assembly. In yet another embodiment, the power supply system may comprise a rechargeable energy storage device, such as a battery or a supercapacitor, integrated within the wheel assembly and configured to power the heating element autonomously. These power supply options may be used individually or in combination, depending on the specific application, installation space, and vehicle architecture.

In a further embodiment, the power supply system may include an electrically conductive bearing or bearing assembly, wherein electrical current is transmitted from a stationary to a rotating component via bearing elements lubricated with conductive grease. This configuration allows continuous electrical contact without the use of slip rings and may offer improved durability and reduced electrical resistance under rotation.

By way of example, the power supply system may be implemented as a transformer-based inductive power supply system. In such a configuration, the system comprises a first coil positioned at or around a vehicle axle and a second coil arranged at the hub of the rim. The first coil may be connected to a vehicle power source, such as a battery, and may include a plurality of windings distributed around the circumference of the axle in order to generate a magnetic field during operation. The second coil is configured to inductively receive power from the first coil and to supply the received energy to the heating element.

In a further refinement, the axle may be hollow and comprise axle walls defining an interior cavity. A first cable extending from the vehicle's power source may be routed through the interior cavity of the axle and connected to the first coil via an opening in the axle wall.

The transformer-based inductive power supply system may further be configured to transmit bidirectional signals, such as control signals, using methods such as pulse-code modulation. This enables communication between rotating and stationary components without physical contacts.

The second coil may be connected to the heating element via a second cable, which can be routed radially outward from the hub of the rim to the heating element and/or to a control unit. The heating element and the control unit may be positioned in the rim well, which comprises an opening for cable routing.

In a particularly compact configuration, the second coil is integrated into a bearing assembly located in the hub of the rim, allowing the rim to rotate around the axle. The magnetic field generated by the first coil induces a current in the second coil even during rotation. The second coil may surround the first coil concentrically when the rim is mounted, thereby enabling efficient coaxial energy transfer.

In some embodiments, the temperature sensor is positioned inside the tire cavity, on the inner liner of the tire, or externally directed toward the tread. The tire cavity refers to the interior volume enclosed by the tire and the rim, typically containing pressurized air. A sensor positioned within this cavity can directly measure the internal air temperature, which is indicative of the thermal state of the tire during operation.

Alternatively, the sensor may be mounted on the inner liner of the tire, which is the innermost layer of the tire structure designed to maintain air pressure. This placement enables the detection of the tire material temperature, providing insight into thermal stresses during dynamic conditions such as acceleration, braking, or cornering.

In another embodiment, the temperature sensor is arranged externally and oriented toward the tread of the tire. This configuration may involve a non-contact measurement principle, such as infrared sensing, to detect the surface temperature of the rotating tire. The described options for positioning the temperature sensor allow for flexible adaptation to various system designs and application scenarios.

Each position offers specific advantages in terms of measurement accuracy, installation feasibility, and responsiveness to thermal changes. This flexibility supports precise thermal monitoring of the tire, which can be used to control heating elements or to inform the user about critical operating conditions.

The control unit may be configured to automatically activate or deactivate the heating element based on predefined temperature thresholds. These thresholds may be set in accordance with various parameters, such as the selected riding mode, the ambient temperature, or the specific type of tire in use.

In certain embodiments, the control unit and/or the heating element may operate in a power-saving mode in order to reduce energy consumption when full heating power is not required. The control unit may further be configured to log temperature profiles over time, thereby enabling a time-based analysis of thermal behavior under different operating conditions. The logged temperature data may be transmitted to an external cloud service or to a mobile application for user access, diagnostics, or system optimization.

In addition, the system may support multiple heating profiles that are selectable by the user or automatically determined by the system, for example warm-up mode, rain mode, or racing mode. Depending on the selected heating profile, the control unit may adjust the heating intensity and the duration of activation accordingly, in order to achieve an optimized tire temperature for the respective application.

The user interface may be positioned on the handlebar of the vehicle or integrated into a mobile device, such as a smartphone or a dedicated control unit. In some embodiments, the user interface comprises a mechanical input device, such as buttons or a rotary switch, a touchscreen for direct interaction, and/or a voice input module that allows hands-free operation. The user interface may further include a display for visual feedback, a speaker for acoustic signals, and a vibration feedback mechanism to provide haptic cues to the user. This allows the user to monitor and control the tire heating system intuitively and in real time, regardless of the environmental conditions or the selected riding mode.

The system may include a wireless communication interface that enables data exchange with external devices. This allows for remote monitoring, configuration, and control of the tire heating system. In some embodiments, the wireless communication interface supports established communication standards such as Bluetooth® or Wi-Fi®, thereby ensuring compatibility with mobile devices, cloud services, or vehicle-mounted control units. This facilitates integration into existing digital ecosystems and enhances user accessibility and system flexibility.

In one embodiment, the invention relates to a vehicle comprising at least one electric tire heating system as described above. The system may be installed on one or more wheels of the vehicle. In an example embodiment, both front and rear wheels are equipped with such a system and are controlled via a single user interface, allowing centralized and synchronized management of the heating functions.

Furthermore, the invention encompasses a method for heating a tire of a vehicle. The method comprises providing a tire heating system as described, or a vehicle equipped with such a system. A desired heating mode or a target temperature may be input via the user interface. The temperature of the tire is detected using the temperature sensor, and the heating element is activated or deactivated based on the detected temperature and the user input. The vehicle may, for example, be a motorcycle.

The heating mode may be selected from various predefined profiles, including warm-up mode, rain mode, sport mode, and energy-saving mode. Each mode is associated with specific control parameters for heating intensity and duration, adapted to different riding conditions and requirements.

In some embodiments, the method further comprises logging the tire temperature data over time and transmitting the logged data to a mobile application or a cloud-based service. This enables long-term monitoring, data analysis, and optimization of the system's performance.

The heating process may also be triggered automatically, for example based on ambient temperature conditions or according to a predefined time schedule. In certain implementations, the method includes charging a local energy storage device—such as a battery or capacitor—prior to the activation of the heating element, in order to ensure sufficient energy availability.

User input may be provided either via a user interface mounted on the handlebar or through a wireless mobile device, depending on the configuration. For safety and efficiency, the system may be configured to disable heating automatically when the vehicle exceeds a predefined speed threshold or when a braking event is detected, thereby preventing overheating during high-speed or high-load situations.

Further examples of embodiments are explained in more detail below with reference to the accompanying drawings. The invention is not intended to be limited solely to these listed examples of embodiments. They merely serve to explain the invention in more detail. The present invention is intended to relate to all objects which the person skilled in the art would use now and, in the future, as obvious to realize the invention.

### BRIEF DESCRIPTION OF DRAWINGS

FIG. 1 shows a schematic representation of an example embodiment of a motorcycle wheel assembly that incorporates a tire pressure management system, depicted in a side view.

FIG. 2 shows a schematic representation of an example embodiment of a motorcycle wheel assembly that incorporates a tire pressure management system, depicted in a top view.

FIG. 3 shows a schematic representation of an example embodiment of a motorcycle wheel assembly that incorporates a tire pressure management system, depicted in a close-up side view.

FIG. 4 shows a schematic representation of an example embodiment of a hub, depicted in a perspective view.

FIG. 5 shows a schematic representation of an example embodiment of a mounting structure of a transformer-based power supply system.

FIG. 6 shows a schematic representation of an example embodiment of a motorcycle axle, depicted in a perspective view.

FIG. 7 shows a schematic representation of an example embodiment of an electrically powered compressor mounted on a rim.

FIG. 8 schematically illustrates the electronic control architecture of an example embodiment of a tire pressure management system.

FIG. 9 shows a schematic representation of a further example embodiment of a motorcycle wheel assembly that incorporates a tire pressure management system, depicted in a top view with a focus on a compressor.

FIG. 10 shows a schematic representation of a further example embodiment of a motorcycle wheel assembly that incorporates a tire pressure management system, depicted in a top view with a focus on a hose connecting the compressor to a reservoir.

FIG. 11 shows a schematic representation of a further example embodiment of an electrically powered compressor mounted on a rim.

FIG. 12 shows a schematic representation of an example embodiment of a reservoir mounted on a rim.

FIG. 13 shows a schematic representation of an example embodiment of a reservoir mounted on a rim, highlighting an outlet valve of the reservoir.

FIG. 14 shows a schematic representation of a further example embodiment of a motorcycle wheel assembly that incorporates a tire pressure management system, depicted in perspective view.

FIG. 15 shows a schematic representation of a further example embodiment of a motorcycle wheel assembly that incorporates a tire pressure management system, depicted in top view.

FIG. 16 shows a schematic representation of a further example embodiment of the inductive power supply system, depicted in a perspective view.

FIG. 17 shows a schematic representation of an example embodiment of a motorcycle wheel assembly that incorporates a system for automated tire sealing, depicted in a top view.

FIG. 18 shows a schematic representation of a further example embodiment of a motorcycle wheel assembly that incorporates a tire pressure management system, depicted in a top view.

FIG. 19 shows a schematic representation of a further example embodiment of a motorcycle wheel assembly that incorporates a tire pressure management system, depicted in a top view with a focus on a means for increasing and decreasing the working volume of the tire cavity.

FIG. 20 shows a schematic representation of a central part of an example embodiment of a manifold, depicted in a perspective view.

FIG. 21 shows a schematic representation of a central part of an example embodiment a manifold, depicted in a front view.

FIG. 22 shows a schematic representation of a front part of an example embodiment of a manifold, depicted in a perspective view.

FIG. 23 shows a schematic representation of a back part of an example embodiment a manifold, depicted in a perspective view.

FIG. 24 shows a schematic representation of an example embodiment of an assembled manifold, depicted in a perspective view.

### DETAILED DESCRIPTION OF ILLUSTRATIVE EMBODIMENTS

Some parts of the embodiments have similar or identical parts. The similar or identical parts may have the same names and/or reference numbers. The description of one part applies by reference to another similar part, where appropriate, thereby reducing repetition of text without limiting the disclosure.

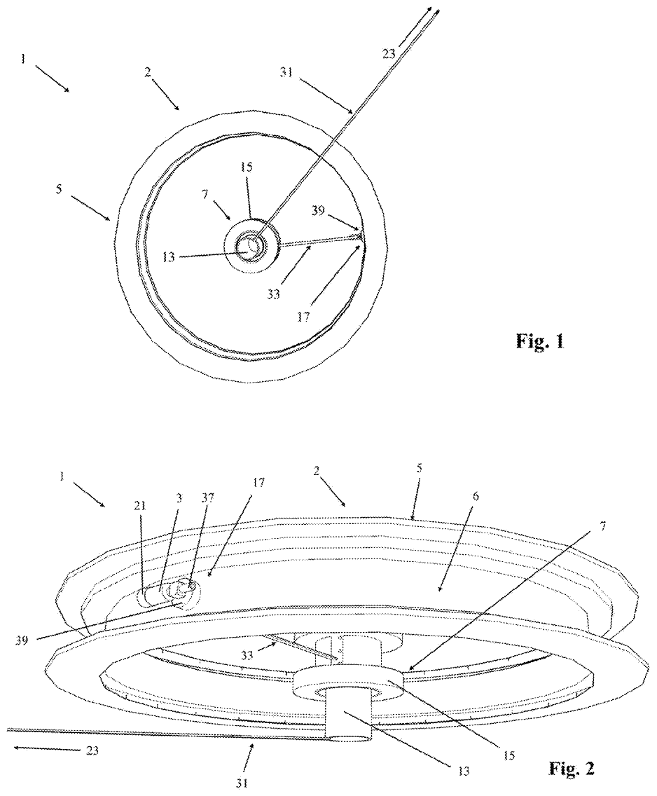

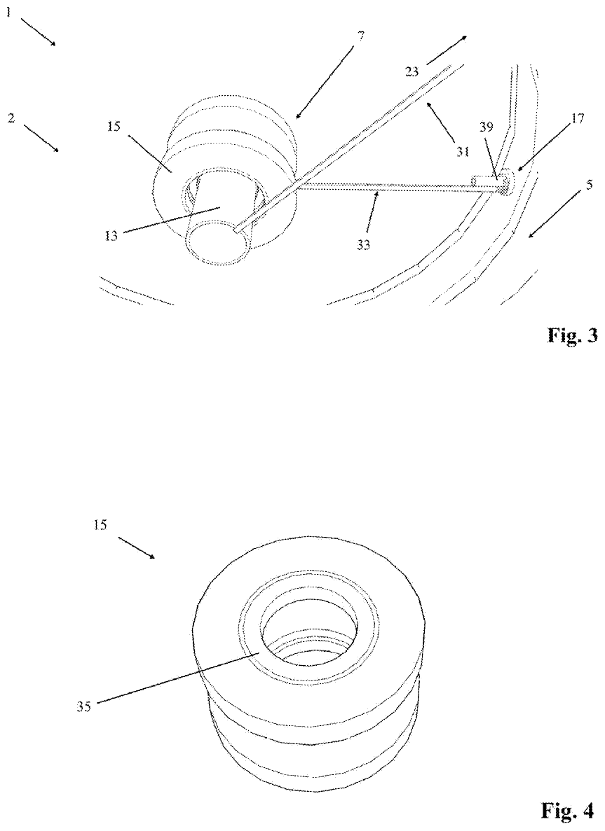

FIG. 1-FIG. 3 show a schematic representation of an embodiment of a motorcycle wheel assembly 2 that incorporates a tire pressure management system 1, depicted in different views.

The tire pressure management system 1 may include an electrically powered compressor 3, which can be mounted on the rim 5 and enclosed within a tire casing, where it can be configured to compress a fluid for adjusting tire pressure. For clarity, the tire casing is not depicted in the figures.

Tire pressure management system 1 may be powered by a transformer-based inductive power supply system 7, which provides electrical energy to the compressor 3. Inductive power supply system 7 can comprise a first coil 9, which may be positioned at the motorcycle axle 13 and configured to generate a magnetic field, and a second coil 11, which may be attached to a hub 15 of rim 5. Second coil 11 may inductively receive power from first coil 9 during operation and may supply power to the compressor 3, thereby providing a wireless power transfer mechanism.

The first coil 9 may be electrically connected to a power source 23, which can be a battery, via a first cable 31, thereby ensuring a continuous power supply to the system. The second coil 11 can be connected to the compressor 3 via a second cable 33, which may be routed so as to extend radially outward from the hub 15 of the rim 5 to the compressor 3. The compressor 3 and the control unit 19 may be disposed within the rim well 6, which can comprise an opening through which the second cable 33 is routed.

The first and second cables 31, 33 may comprise, in addition to conductors for power transmission, dedicated wires for bidirectional signal communication, enabling data exchange or bidirectional signal transmission between system components.

A control unit 19, which is not shown in FIGS. 1-3, may be equipped with a microprocessor and can be in signal communication with the compressor 3 and/or the valve unit 17. The control unit 19 may be designed to either receive user commands via a user interface 41, allowing manual pressure adjustments, and/or to automatically regulate tire pressure based on input from one or more sensors 21. These sensors 21 may detect tire pressure, temperature, and load conditions, enabling real-time monitoring and adaptive adjustments to optimize performance, safety, and riding comfort.

To regulate airflow, the system may include a valve unit 17 that enables bidirectional fluid flow and can be operatively coupled to the compressor 3, establishing fluid communication between the compressor 3 and the external atmosphere. The valve unit 17 may comprise a valve stem 39, which is operatively coupled with a deflation valve 37 and the compressor 3. The valve stem 39 can be designed to both admit and release fluid, ensuring controlled tire pressure adjustments. The valve stem 39 can extend through an opening in the rim well 6, with the compressor 3 and the deflation valve 37 being directly coupled to it.

The deflation valve 37, can be configured to release fluid from the tire casing when reducing tire pressure is required. The deflation valve 37 may be an electronically controlled valve, which can be in signal communication with the control unit 19, allowing both automated and/or user-controlled pressure regulation.

FIG. 4 shows a schematic representation of an example embodiment of a hub 15 depicted in a perspective view. In particular, FIG. 4 illustrates details of the hub 15 used in the embodiments of FIGS. 1-3.

The second coil 11 may be integrated into a bearing assembly 35, which can be positioned in the hub 15 of the rim 5 and can allow the rim 5 to rotate around the axle 13. The second coil 11 may be positioned in the bearing assembly 35 in such a way that a magnetic field generated by the first coil 9 induces a current in the second coil 11 when the rim 5 rotates. In particular, the second coil 11 may be integrated within the bearing assembly 35, such that the second coil 11 surrounds the first coil 9 when the rim 5 is mounted on the axle 13.

The bearing assembly 35 may comprise two bearings, which may, for example, be configured as ball bearings. These bearings may be positioned on both sides of the hub 15 and/or axle 13, in proximity to the side surfaces of the hub 15. A spacer may be arranged between the bearings, the outer diameter of which corresponds to the inner race of the bearings. This spacer provides lateral support to the bearings, helping to prevent wear during cornering and other riding scenarios that apply lateral forces to the wheel assembly 2.

The hub 15 may be not mounted on the spacer itself. Technically, the hub 15 can be mounted onto the outer race of the bearings, while the inner race of the bearings can be mounted on the axle 13. The spacer may be freely floating on the axle. When the bearings are pressed into place, they may create a snug fit against the spacer. The second coil 11 may be integrated within the spacer.

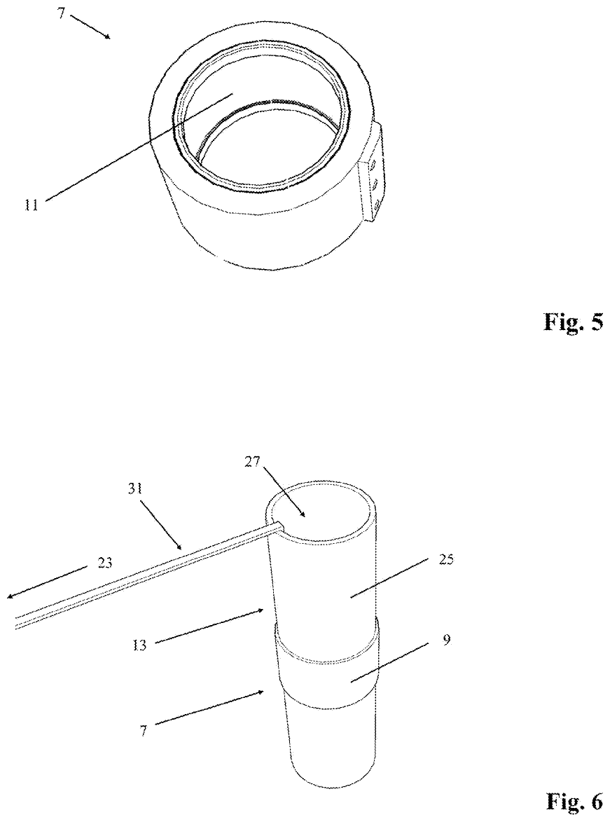

FIG. 5 shows a schematic representation of a mounting structure of a transformer-based inductive power supply system 7, which accommodates the second coil 11 and may be integrated within the bearing assembly 35 of the hub 15.

FIG. 6 shows a schematic representation of an embodiment of a motorcycle axle 13, depicted in a perspective view. In particular, FIG. 6 illustrates details of the axle 13 used in the embodiments of FIGS. 1-3.

As previously described in the context of FIGS. 1-3, the first coil 9 of the inductive power supply system 7 may comprise a plurality of windings that are applied around the circumference of the axle 13. In this regard, a spacer or adapter can be provided, onto which the windings may be applied, or in which the windings are integrated, or beneath which the windings are positioned. The spacer or adapter can be mounted on the axle 13 to ensure correct positioning of both the bearings of the bearing assembly and the coil 9, while also ensuring secure attachment.

The axle 13 can be hollow and may comprise axle walls 25 that define an interior cavity 27. A first cable 31, extending from the vehicle's power source 23, can be routed through the interior cavity 27 of the axle 13, with the first coil 9 being electrically connected to the first cable 31 through an opening in the axle wall 25.

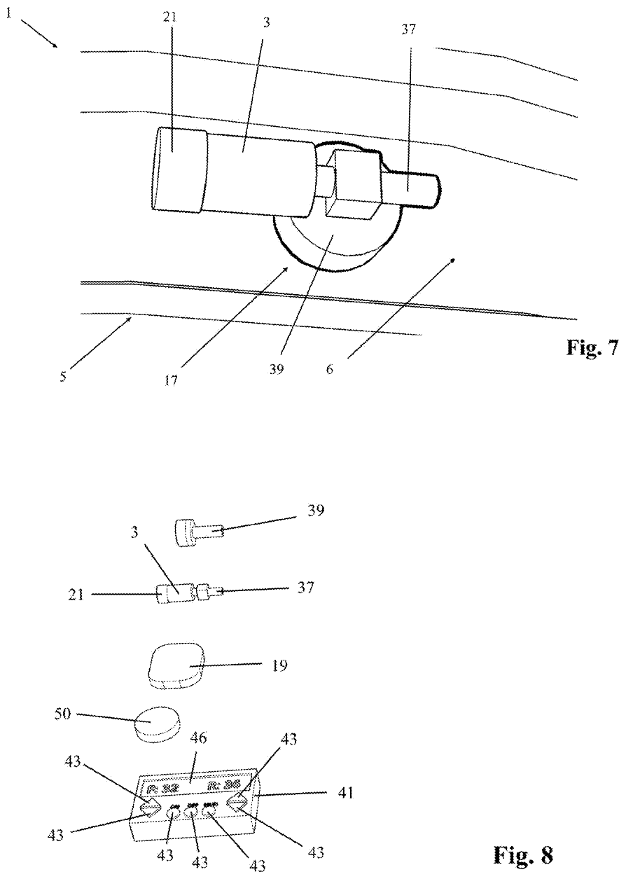

FIG. 7 shows a schematic representation of an example embodiment of an electrically powered compressor 3 mounted on a rim 5. The rim 5 may comprise a U-shaped cross-section, wherein the lowest part of the U defines a rim well 6, which is surrounded by walls to which the tire can be attached.

The compressor 3 can be coupled to a valve unit 17. The valve unit 17 may comprise a deflation valve 37, which is configured to release fluid from the tire casing to reduce tire pressure. Additionally, the valve unit 17 may include a valve stem 39 operatively coupled with both the deflation valve 37 and the compressor 3, wherein the valve stem 39 is configured to both admit and release fluid.

The valve stem 39 can be routed through an opening in the rim well 6, with the compressor 3 and the deflation valve 37 directly mounted on it. The deflation valve 37 may comprise an electrically controlled valve in signal communication with a control unit 19 (not shown in FIG. 7). The control unit 19 may also be in signal communication with the compressor 3 and a sensor 21.

The sensor 21 can be mounted on the housing of the compressor 3, wherein the control unit 19 is configured to analyze and process sensor data and/or provide sensor data to a user interface 41.

In some example implementations, the compressor 3 may be a miniature rotary compressor or a diaphragm compressor, specifically designed for compact integration within the rim 5 structure, ensuring minimal vibration and efficient operation.

The compressor 3 may include an opening 45 (not shown in FIG. 7) for introducing compressed air into the tire. Alternatively, the deflation valve 37 can be used for this purpose, depending on the operating mode of the system. The control unit 19 may manage the airflow direction by selectively activating the compressor 3 and/or the deflation valve 37.

FIG. 8 schematically illustrates a electronic control architecture of an example embodiment of a tire pressure management system 1.

At the top of the figure, an air inlet is depicted, designed as a valve stem 39. This allows for manual inflation of the tire in case of a system 1 malfunction or for any other reason requiring conventional inflation by the user.

Furthermore, a compressor 3 is shown, which may include its own control unit with a microprocessor and a wireless communication module. The compressor 3 incorporates a motor for generating compressed air and an air manifold for distributing the compressed air.

A pressure and/or temperature sensor 21 may be attached to the compressor 3 and coupled to its control unit.

Additionally, the compressor 3 may be connected to a deflation valve 37, which is a solenoid-actuated valve. The deflation valve 37 may also be controlled by the compressor's control unit.

Moreover, a main microprocessor is illustrated, which may function as the primary control unit 19 of the entire tire pressure management system 1. This control unit 19 may represent the central control system of a vehicle, such as a motorcycle. It can integrate data from GPS, accelerometers, and other sensors 21 to dynamically adjust tire pressure based on real-time riding conditions. The control unit 19 may be in signal communication with the compressor's control unit.

Further, suspension accelerometers 50 are indicated. These may be integrated into the existing suspension system (e.g., the GS model's native sensors) to assist in automatic suspension setting adjustments and potentially influence tire pressure settings.

At the bottom of the figure, a user interface 41 is illustrated. This interface 41 provides manual adjustments and may include three preset modes for tire pressure control. It allows the user to select tire pressures manually or monitor the current status, as indicated by the displayed front F: 32 and rear R: 36 tire pressures.

The user interface 41 may be configured to receive input from the user and is in signal or data communication with the control unit 19. The user interface 41 may comprise a mechanical input device such as a button 43, a touch display for inputting signals, and/or a microphone for receiving voice commands. It also may include a mechanical output device such as a vibration motor, a display 46 for presenting visual signals, and/or a speaker for outputting audio signals.

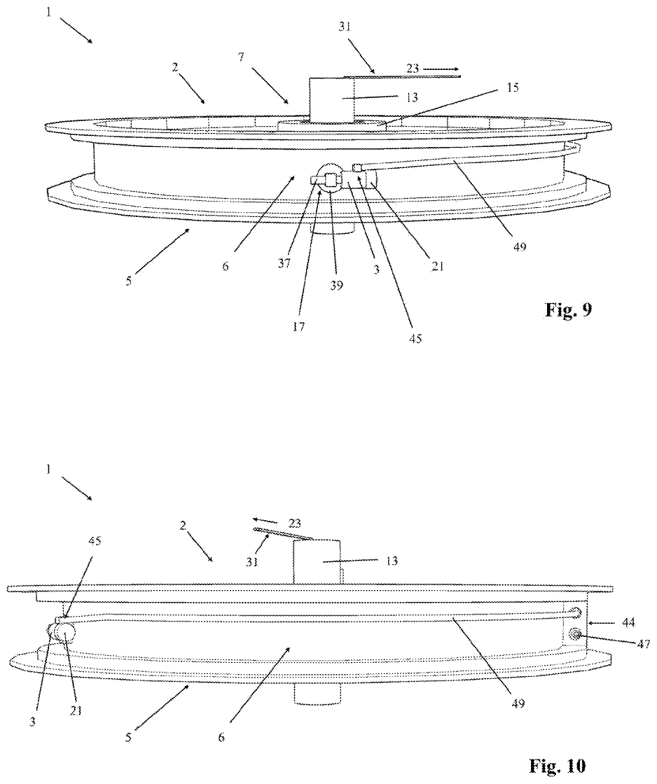

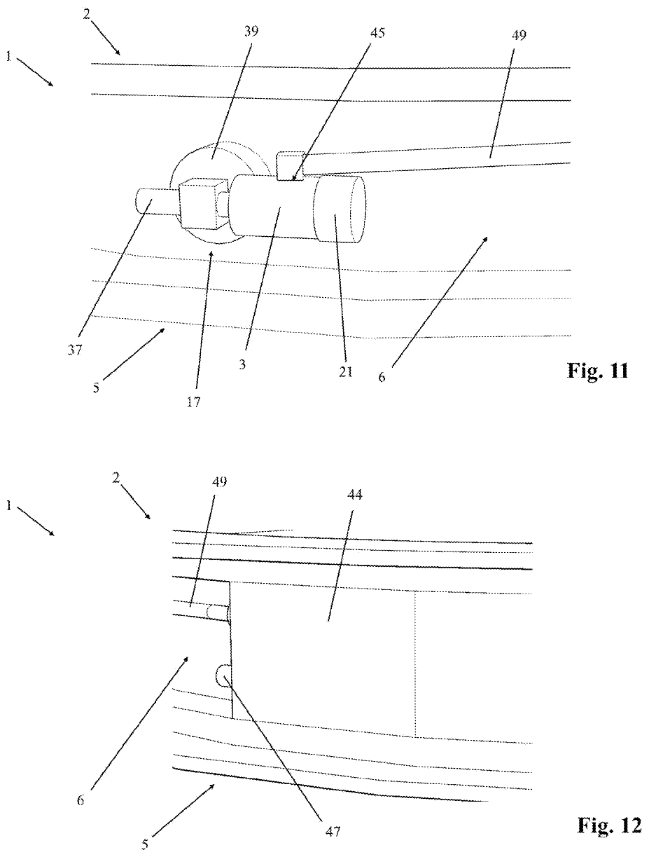

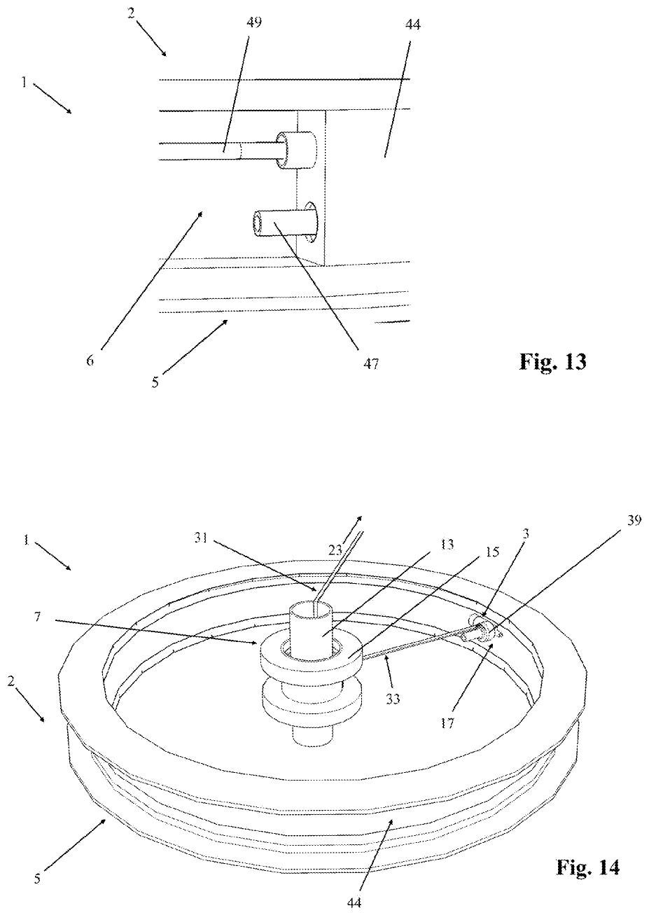

FIG. 9-FIG. 13 show a schematic representation of a further embodiment of a motorcycle wheel assembly 2 that incorporates a tire pressure management system 1, depicted in different views. This embodiment is based on the version shown in FIGS. 1-8 and extends it by integrating an additional reservoir 44 within the tire pressure management system 1. To avoid repetition, reference is made to the preceding descriptions of FIGS. 1-8.

The reservoir 44 may be integrated within the tire casing, being fluidly isolated from the internal fluid volume of the tire casing. It may be operatively coupled to the compressor 3 for storing compressed fluid and enabling rapid pressure adjustments when needed. The reservoir 44 may be fluidly connected to an outlet 45 of the compressor 3 via a hose 49. It may extend over a partial region of the circumference of the rim well 6 of the rim 5 and is positioned on the opposite side of the rim well 6 relative to the compressor 3.

The reservoir 44 may include an outlet valve 47 configured to release fluid from the reservoir 44 into the tire casing. The outlet valve 47 may comprise an electrically controlled valve in signal communication with the control unit 19. The control unit 19 may be configured to open the outlet valve 47 in response to user input via the user interface 41 or automatically based on sensor 21 measurements.

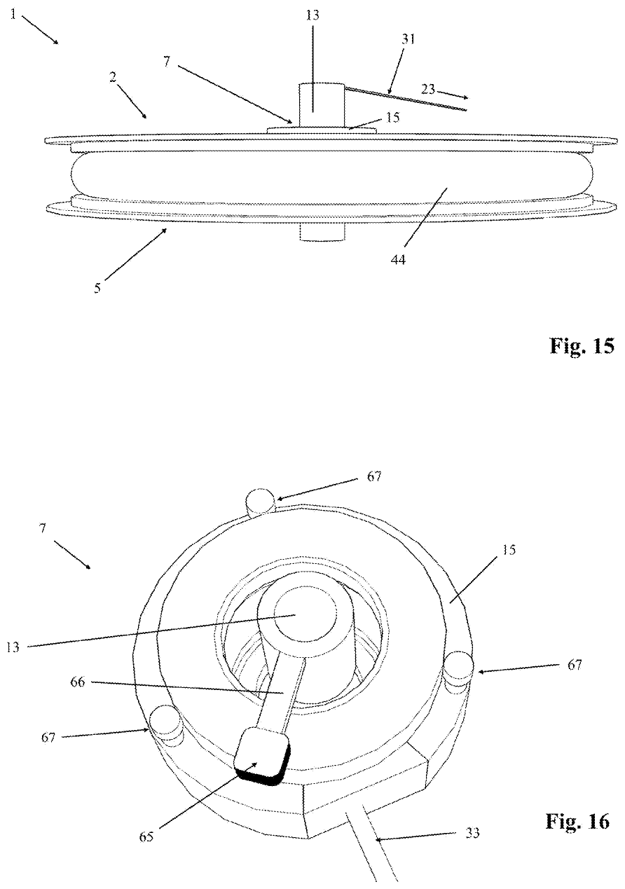

FIG. 14 and FIG. 15 show a schematic representation of a further embodiment of a motorcycle wheel assembly 2 incorporating a tire pressure management system 1, depicted from different perspectives. In contrast to the embodiment shown in FIG. 9-FIG. 13, a different design of the reservoir 44 is used. Reference is made to the descriptions according to FIG. 1-FIG. 13.

The reservoir 44 may be configured to extend around the entire circumference of the rim well 6.

FIG. 16 shows a schematic representation of a further embodiment of the inductive power supply system 7, depicted in a perspective view. A permanent magnet 65 may be coupled to the axle 13, for example via a mounting bracket 66, such that the permanent magnet 65 maintains a defined distance from the axle 13. A hub 15 may mounted on the axle 13, the hub 15 comprising three coils 67 that are operatively connected to the second cable 33. The hub 15 may rotate when the vehicle, such as a motorcycle, is in motion.

The coils 67 may be positioned on the hub 15 in such a way that, during each rotation, they pass in close proximity to the permanent magnet 65. This relative movement induces an alternating current in the coils 67 due to the changing magnetic flux. The induced current may be conducted via the second cable 33 to an electrical consumer, such as a compressor, thereby supplying it with electrical energy.

The number and positioning of the coils 67 on the hub 15 may be selected to optimize the efficiency of energy conversion based on the rotational speed and magnetic field strength. Additionally, the permanent magnet 65 may be arranged in such a way that it generates a consistent and focused magnetic field along the path of the coils 67 to ensure reliable induction with minimal losses. The mounting bracket 66 may be adjustable or elastically suspended to maintain the optimal air gap between the magnet and the coils, even under vibration or thermal expansion during operation.

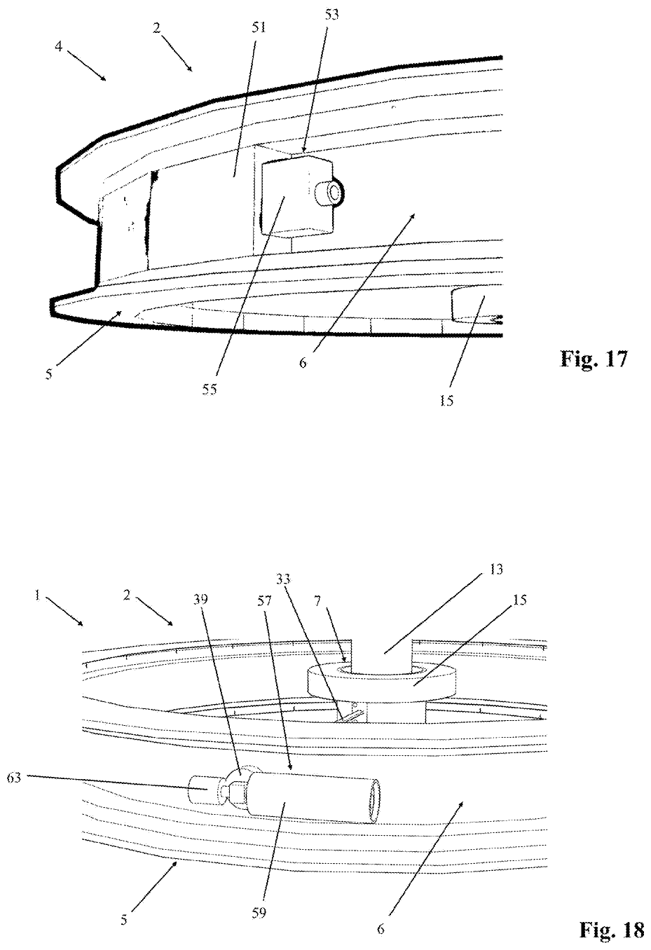

FIG. 17 shows a schematic representation of an example embodiment of a motorcycle wheel assembly 2 that incorporates a system 4 for automated tire sealing, depicted in a top view.

The system 4 may include a sealant reservoir 51 integrated within the tire casing for storing a sealing fluid in a deployable state. The sealant reservoir 51 may be positioned along the rim well 6 of the rim 5 and remains fluidly isolated from the tire's internal air volume until activation.

Further, the system 4 may comprise a sensor system 21 (not depicted in FIG. 17) designed to detect a pressure drop or leakage in the tire. The sensor system 21 may incorporate a tire pressure sensor capable of monitoring the current tire pressure in real time.

The system 4 may also comprise a sealant shooter mechanism 53, operatively connected to the sealant reservoir 51, designed to inject a predefined amount of sealing fluid into the inner tire cavity upon detecting a pressure drop or leakage. The sealant shooter mechanism 53 may feature a pressurized injection system, which may include a micro-pump or a CO₂ cartridge-based expulsion unit 55.

The natural rotation of the tire to distribute the sealing fluid across the inner surface may be provided as a dispersion mechanism. The sealing fluid may include a self-curing polymer-based composition capable of sealing punctures up to a predefined size threshold.

The system may comprise an automated valve control unit that regulates the injection timing and volume of the sealant fluid based on the severity of the pressure drop.

The system may further comprise a control unit that communicates with the tire pressure management system 1 to provide real-time feedback on tire status and sealing effectiveness.

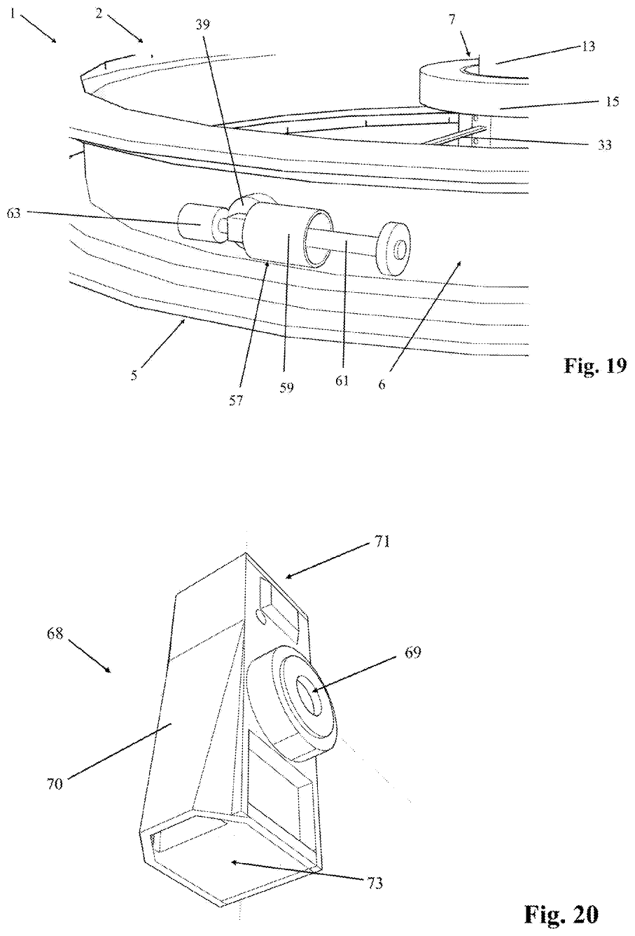

FIG. 18 and FIG. 19 each show a schematic representation of a further example embodiment of a motorcycle wheel assembly 2 that incorporates a tire pressure management system 1, depicted in a top view.

The tire pressure management system 1 may comprise a tire cavity having a working volume configured to contain an air volume for maintaining an operating tire pressure.

A means 57 located within the tire cavity may be provided for increasing and decreasing the working volume of the tire cavity to adjust the internal tire pressure. The means 57 may comprise a cylinder 59 with a sealed piston 61, which is configured to extend and retract to modify the working volume of the tire cavity, thereby adjusting the internal tire pressure. The piston 61 may be operably coupled to an electric motor 63, which is powered by a power supply system and/or a control unit 19.

FIG. 19 depicts the cylinder 59 in a partially cut-away view, revealing the piston 61.

The means 57 may further comprise in an alternative embodiment one or more of the following components: bladders, membranes, solenoids, motors, or other actuators, all operably connected to the power supply system 7 and the control unit 19, and configured to modify the working volume of the tire cavity.

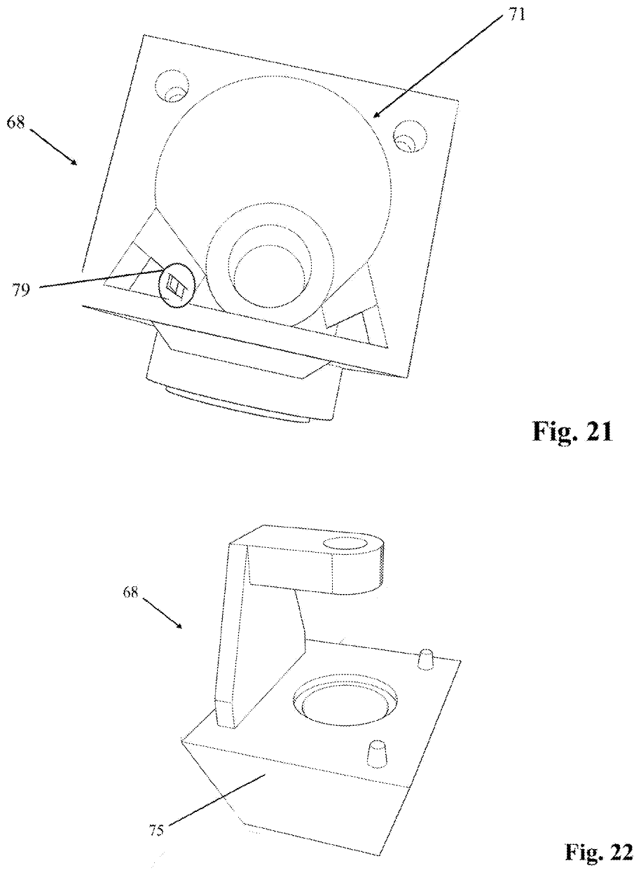

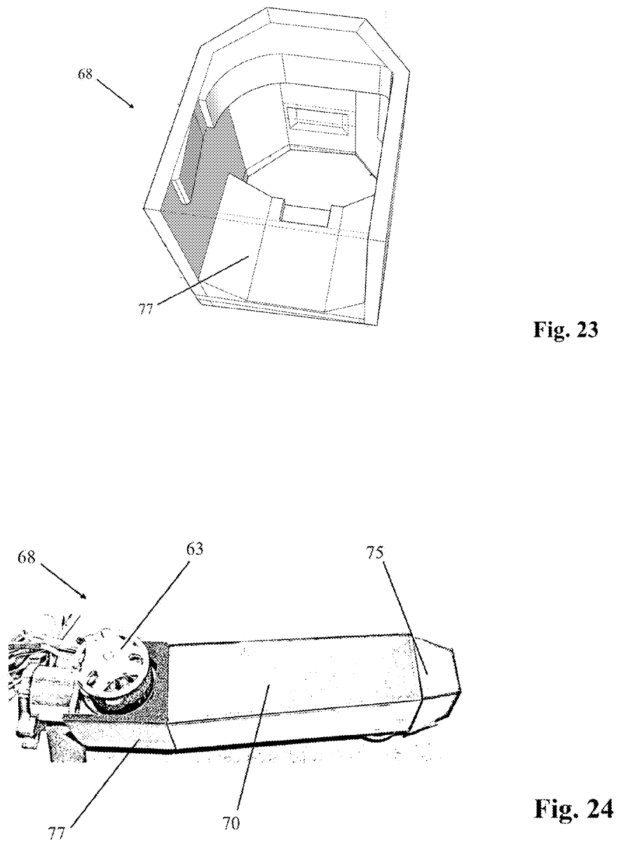

FIG. 20-FIG. 24 show schematic representations of a manifold 68, depicted in different perspective views. FIGS. 20 to 23 illustrate individual components of the manifold 68 in a disassembled state, whereas FIG. 24 shows the manifold 68 in its assembled state.

The manifold 68 may be designed as a compact structural housing that mechanically and functionally integrates multiple components of the system, including the compressor 3, the valve unit 17, the valves 37, 45, and/or the valve stem 39. This configuration enables a close coupling of all essential pneumatic components within a single unit.

The manifold 68 may comprise three parts: a central part 70, a front part 75, which is mounted to a front side 71 of the central part 70, and a rear part 77, which is mounted to the rear side of the central part 70. The central part 70 may include a threaded section 69 on its underside, which is configured to be screwed onto a threaded portion of the valve stem 39.

The valve stem 39 may accordingly include a threaded section into or onto which the manifold 68 can be screwed, thereby allowing for direct mounting to the rim 5.

The manifold 68 may further comprise internal channels or cavities within the housing, which guide pressurized air between the compressor 3, the valve unit 17 or valves 37, and/or the valve stem 39. These internal flow paths may also provide fluid communication between the tire and the external environment—for example, when the valve unit 17 includes a deflation valve 37.

In such a configuration, air can be selectively released from the tire through the manifold 68, enabling both inflation and deflation functions to be integrated into a single, compact unit.

In particular, the compressor 3 inlet and the low-pressure side of the deflation valve 37 may be connected and both may be vented through a cylindrical structure protruding from the bottom of the manifold 68 (which contains the threaded nut) and leads to the valve stem 39. Reference numeral 79 denotes the airway that connects the compressor 3 inlet to the internal section of the manifold 68.

In certain embodiments, the manifold 68 may also incorporate electronic components such as pressure sensors, sensor systems, or control electronics (e.g., a control unit). These components may be connected to a central control unit 19 via electrical lines or wireless communication interfaces.

The electric motor 63 of the compressor 3 may comprise a rotational axis about which a rotor rotates relative to a stator. This rotational axis may be oriented substantially parallel to the axle 13 of the wheel assembly 2—around which the rim 5 and/or tire and/or hub 15 rotates when the vehicle is in motion.

The compressor including the electric motor may be integrated into the rear part 77 of the manifold 68. In contrast, the deflation valve 37 may be integrated into the front part 75.

The above-mentioned embodiments may also be alternatively described using the following itemized lists.

The items of the first itemized list can be combined with one or more items of all other itemized lists in this document as well as with one or more features of the claims.

First itemized list:
1. A tire pressure management system 1 for a vehicle, comprising:
   an electrically powered compressor 3 mounted on a rim 5 and encased within a tire casing, configured to compress a fluid for adjusting tire pressure;
   a transformer-based inductive power supply system 7 for providing electrical power to the compressor 3, wherein:
      a first coil 9 positioned at a vehicle axle 13 is configured to generate a magnetic field; and
      a second coil 11 attached to a hub 15 of the rim 5 is configured to inductively receive power from the first coil 9 during operation and supply it to the compressor 3;
   a valve unit 17 enabling bidirectional fluid flow to regulate tire pressure, operatively coupled to the compressor 3 to establish fluid communication between the compressor 3 and the external atmosphere;
   a control unit 19 having a microprocessor being in signal communication with the compressor 3 and/or the valve unit 17, configured to:
      receive user commands to manually adjust tire pressure by controlling the compressor 3 and/or the valve unit 17 based on the commands; and/or
      automatically control the compressor 3 and/or the valve unit 17 based on input from one or more sensors 21 detecting parameters, including but not limited to, tire pressure, temperature, or load conditions.
2. The system 1 according to item 1, further comprising a reservoir 44 integrated within the tire casing, being fluidly isolated from the internal fluid volume of the tire casing, operatively coupled to the compressor 3 for storing compressed fluid and facilitating rapid pressure adjustments when needed.
3. The system 1 according to item 2, wherein the reservoir 44 extends over a partial region of the circumference of the rim well 6 of the rim 5 and is located on the side of the rim well 6 opposite the compressor 3.
4. The system 1 according to item 2, wherein the reservoir 44 is configured to extend around the entire circumference of the rim well 6.

The items of the second itemized list can be combined with one or more items of all other itemized lists in this document as well as with one or more features of the claims.

Second itemized list:
5. A tire pressure management system 1 for a vehicle, comprising:
   an electrically powered compressor 3 mounted on a rim 5 and encased within a tire casing, configured to compress a fluid for adjusting tire pressure;
   a power supply system for providing electrical power to the compressor 3,
   a valve unit 17 enabling bidirectional fluid flow to regulate tire pressure, operatively coupled to the compressor 3 to establish fluid communication between the compressor 3 and the external atmosphere;
   a reservoir 44 integrated within the tire casing being fluidly isolated of the internal fluid volume of the tire casing, operatively coupled to the compressor 3 for storing compressed fluid and facilitating rapid pressure adjustments when needed, wherein the reservoir 44 extends over a partial region of the circumference of a rim well 6 of the rim 5 and is located on the side of the rim well 6 opposite the compressor 3;
   a control unit 19 having a microprocessor in signal communication with the compressor 3, the reservoir 44 and/or the valve unit 17, configured to:
      receive user commands to manually adjust tire pressure by controlling the compressor 3, the reservoir 44, and/or the valve unit 17 based on the commands; and/or
      automatically control the compressor 3, reservoir 44 and/or the valve unit 17 based on input from one or more sensors 21 detecting parameters, including but not limited to, tire pressure, temperature, or load conditions.
6. The system 1 according to item 5, wherein the power supply system 7 comprises a transformer-based inductive power supply system 7, wherein:
   a first coil 9, positioned at a vehicle axle 13, is configured to generate a magnetic field; and
   a second coil 11, attached to a hub 15 of the rim 5, is configured to inductively receive power from the first coil 9 during operation and supply it to the compressor 3.

The items of the third itemized list can be combined with one or more items of all other itemized lists in this document as well as with one or more features of the claims.

Third itemized list:
7. A tire pressure management system 1 for a vehicle, comprising:
   an electrically powered compressor 3 mounted on a rim 5 and encased within a tire casing, configured to compress a fluid for adjusting tire pressure;
   a power supply system for providing electrical power to the compressor 3,
   a valve unit 17 enabling bidirectional fluid flow to regulate tire pressure, comprising a valve stem 39 and a deflation valve 37, wherein the valve stem 39 is operatively coupled to both the compressor 3 and the deflation valve 37;
   a reservoir 44 integrated within the tire casing being fluidly isolated of the internal fluid volume of the tire casing, operatively coupled to the compressor 3 for storing compressed fluid and facilitating rapid pressure adjustments when needed, wherein the reservoir 44 is configured to extend around the entire circumference of a rim well 6 of the rim 5;
   a control unit 19 having a microprocessor in signal communication with the compressor 3, the reservoir 44 and/or the valve unit 17, configured to:
      receive user commands to manually adjust tire pressure by controlling the compressor 3, the reservoir 44, and/or the valve unit 17 based on the commands; and/or
      automatically control the compressor 3, reservoir 44 and/or the valve unit 17 based on input from one or more sensors 21 detecting parameters, including but not limited to, tire pressure, temperature, or load conditions.
8. The system 1 according to item 7, wherein the power supply system 7 comprises a transformer-based inductive power supply system 7, wherein:
   a first coil 9, positioned at a vehicle axle 13, is configured to generate a magnetic field; and
   a second coil 11, attached to a hub 15 of the rim 5, is configured to inductively receive power from the first coil 9 during operation and supply it to the compressor 3.

The items of the fourth itemized list can be combined with one or more items of all other itemized lists in this document as well as with one or more features of the claims.

Fourth itemized list:
9. The system 1 according to any of the preceding items 1-8, wherein the vehicle is a motorcycle.
10. The system 1 according to any of the preceding items 1-9, wherein the reservoir 44 is fluidly connected to an outlet 45 of the compressor 3 via a hose 49.
11. The system 1 according to any of the preceding items, wherein the reservoir 44 includes an outlet valve 47 configured to release fluid from the reservoir 44 into the tire casing.
12. The system 1 according to item 11, wherein the outlet valve 47 comprises an electrically controlled valve in signal communication with the control unit 19.
13. The system 1 according to item 12, wherein the control unit 19 is configured to open the outlet valve 47 in response to user input via the user interface 43 or automatically based on sensor 21 measurements.
14. The system 1 according to any of the preceding items, wherein the first coil 9 is connected to a power source 23 of the vehicle, particularly to a battery.
15. The system 1 according to any of the preceding items, wherein the first coil 9 comprises a plurality of windings applied around the circumference of the axle 13.
16. The system 1 according to item 15, wherein the axle 13 is hollow and comprises axle walls 25 that define an interior cavity 27, a first cable 31 extending from the vehicle's power source 23 is routed through the interior cavity 27 of the axle 13, and the first coil 9 is electrically connected to the first cable 31 through an opening in the axle wall 25.
17. The system 1 according to any of the preceding items, wherein the transformer-based inductive power supply system 7 is further configured to transmit bidirectional signals, such as control signals, using methods such as pulse-code modulation.
18. The system 1 according to any of the preceding items, wherein the second coil 11 is connected to the compressor 3 via a second cable 33, the second cable 33 being routed radially outward from the hub 15 of the rim 5 to the compressor 3 and/or the control unit 19, wherein the compressor 3 and the control unit 19 are located in the rim well 6, the rim well 6 comprising an opening through which the second cable 33 is routed.
19. The system 1 according to any of the preceding items 16-18, wherein the first and second cables 31, 33 comprise, in addition to wires for transmitting power, wires for bidirectional signal transmission.
20. The system 1 according to any of the preceding items, wherein the second coil 11 is integrated into a bearing assembly 35 that is positioned in the hub 15 of the rim 5 and allows the rim 5 to rotate around the axle 13, wherein the second coil 11 is positioned in the bearing assembly 35, such that a magnetic field generated by the first coil 9 induces a current in the second coil 11 when the rim 5 rotates.
21. The system 1 according to item 20, wherein the second coil 11 is integrated within the bearing assembly 35, such that the second coil 11 surrounds the first coil 9 when the rim 5 is mounted on the axle 13.
22. The system 1 according to any of the preceding items, wherein the compressor 3 is a miniature rotary compressor or a diaphragm compressor, specifically designed for compact integration within the rim 5 structure, ensuring minimal vibration and efficient operation.
23. The system 1 according to any of the preceding items, wherein at least one sensor 21 is mounted on the compressor 3 housing and is in signal communication with the control unit 19, wherein the control unit 19 is configured to analyze and process sensor data and/or to provide sensor data to the user interface.
24. The system 1 according to any of the preceding items, wherein the valve unit 17 comprises a deflation valve 37, configured to release fluid from the tire casing to reduce tire pressure.
25. The system 1 according to item 24, wherein the deflation valve 37 comprises an electrically controlled valve being in signal communication with the control unit 19.
26. The system 1 according to item 24 or item 25, wherein the valve unit 17 comprises a valve stem 39 operatively coupled with the deflation valve 37 and the compressor 3, wherein the valve stem 39 can both admit and release fluid.
27. The system 1 according to item 26, wherein the valve stem 39 is passed through an opening in the rim well 6, and the compressor 3 and the deflation valve 37 are directly mounted on the valve stem 39.
28. The system 1 according to any of the preceding items, wherein the control unit 19 is in signal communication with a user interface 41, which is configured to receive input from a user.
29. The system 1 according to item 28, wherein the user interface 41 comprises a mechanical input device such as a button 43, a touch display for entering signals, and/or a microphone for receiving audio signals.
30. The system 1 according to item 28 or item 29, wherein the user interface 41 comprises a mechanical output device such as a vibration motor, a display 46 for presenting visual signals, or a speaker for outputting audio signals.
31. The system 1 according to any of the preceding items, wherein the user interface 41 is coupled to the first cable 31 and the control unit 19 is coupled to the second cable 33, and signal communication is enabled through signal transmission via the inductive coupling of the first and second coils 9, 11 and/or via wireless communication such as Bluetooth® communication.
32. A motorcycle comprising a tire pressure management system 1 according to any of the preceding items 1-31.
33. The motorcycle according to item 32, wherein the system 1 is configured for managing the front or rear tire pressure.
34. A motorcycle comprising two tire pressure management systems 1 according to any of items 1-31, wherein both systems 1 can be controlled by a user via a single user interface 43.
35. A method for controlling tire pressure in a motorcycle tire, comprising:
   providing a system 1 according to any of items 1-31 or a motorcycle according to items 32-34;
   inputting a desired pressure value for the front or rear tire via a user interface 43, based on which the control unit 19 adjusts the pressure; and/or
   detecting parameters via sensors 21, transmitting the detected parameters to the control unit 19, and automatically adjusting the tire pressure based on the detected parameters.
36. The method according to item 35, wherein the motorcycle is either stationary or in motion during controlling tire pressure.
37. The method according to item 35 or item 36, wherein a user is either seated on the motorcycle or not during controlling tire pressure.

The items of the fifth itemized list can be combined with one or more items of all other itemized lists in this document as well as with one or more features of the claims.

Fifth itemized list:
38. A method for controlling the tire pressure of a tire in a vehicle comprising a tire pressure management system 1 with an electrically powered compressor 3 mounted on a rim 5, a valve unit 17, a power supply system 7 for providing electrical power to the compressor 3 and a control unit 19 for controlling the compressor 3 and the valve unit 17, the method comprising:
   a. Storing a plurality of tire pressure values in a database using a data processing unit comprising at least a memory and a processor, wherein the tire pressure values are associated with weight parameters, including the weight of the rider, luggage, and/or passengers;
   b. Determining a target tire pressure based on either a manual input of the rider's, luggage's, and/or passengers' weight by a user, or by an automatic determination of the rider's, luggage's, and/or passengers' weight using a sensor system 21, wherein the target tire pressure corresponds to the tire pressure value associated with the manually inputted or automatically determined weight;
   c. Detecting the current tire pressure in a tire using the sensor system 21 and providing the value of the current tire pressure to the data processing unit;
   d. Comparing the current tire pressure with the target tire pressure using the data processing unit;
   e. If the current tire pressure deviates from the target tire pressure or exceeds a predefined threshold, adjusting the tire pressure by:
      i. Activating the compressor 3 to compress a fluid and increase the tire pressure until the target pressure is reached, or
      ii. Activating the valve unit 17 to release fluid the tire into the external atmosphere to decrease the tire pressure until the target pressure is reached.
39. The method according to item 38, wherein the vehicle is a motorcycle.
40. The method according to item 38 or item 39, wherein the tire pressure values are also associated with predefined riding modes, such as off-road, street, sport, or eco, and the method further comprises the step of:
   i. Modifying the target tire pressure based on a manual selection of a riding mode by a user, wherein the target tire pressure corresponds to the tire pressure value associated with the selected riding mode.
41. The method according to any of the preceding items, wherein the control unit 19 is in data communication with the data processing unit.
42. The method according to any of the preceding items, wherein the data processing unit comprises a user interface 41 configured to receive input from a user, wherein the user interface 41 is used for manual selection of a riding mode and/or manual input of the rider's, luggage's, and/or passengers' weight.
43. The method according to item 42, wherein the user interface 41 comprises a mechanical input device such as a button 43, a touch display for entering signals, and/or a microphone for receiving audio signals.
44. The method according to item 42 or item 43, wherein the user interface 41 comprises a mechanical output device such as a vibration motor, a display 46 for presenting visual signals, or a speaker for outputting audio signals.
45. The method according to any of the preceding items 38-44, further comprising:
   a. Detecting, using the sensor system 21, at least one operating parameter selected from the group consisting of:
      Suspension travel data, including compression and rebound speed
      Suspension compression level;
      Road conditions or surface properties,
      Motion and dynamic state data, including acceleration, angular velocity, and orientation
   b. Storing and analyzing the detected operating parameters using the data processing unit comprising a memory and a processor;
   c. Modifying the target tire pressure based on at least one detected operating parameter.
46. The method according to any of the preceding items 38-45, further comprising:
   a. Detecting road and chassis conditions using the sensor system 21, wherein the detected parameters are selected from the group consisting of:
      Suspension movement and compression patterns averaged over time;
      Chassis vibration or structural displacement data;
      Road condition data obtained from a database based on GPS location;
      Historical onboard road condition data stored in memory and correlated with GPS positioning.
   b. Modifying the target tire pressure based on the road and chassis conditions using the data processing unit;
47. The method according to any of the preceding items 38-46, wherein the sensor system comprises one or more sensors selected from the group consisting of:
   a. A camera configured to detect road conditions or surface properties;
   b. An inertial measurement unit (IMU) configured to capture acceleration, angular velocity, and orientation changes of the vehicle;
   c. A suspension position sensor configured to measure suspension compression level and travel data;
   d. A tire pressure sensor configured to detect the current tire pressure in real-time;
   e. A load sensor configured to determine the weight of the rider, luggage, and/or passengers;
   f. A vibration sensor configured to detect chassis vibrations and structural displacements.

The items of the sixth itemized list can be combined with one or more items of all other itemized lists in this document as well as with one or more features of the claims.

Sixth itemized list:
48. A method determining an optimal target tire pressure of a tire in a vehicle comprising a tire pressure management system 1 with an electrically powered compressor 3 mounted on a rim 5, a valve unit 17, a power supply system 7 for providing electrical power to the compressor 3 and a control unit 19 for controlling the compressor 3 and the valve unit 17, the method comprising:
   a. Detecting, using a sensor system 21, at least one operating parameter selected from the group consisting of:
      i. Suspension travel data, including compression and rebound speed
      ii. Suspension compression level;
      iii. Road conditions or surface properties,
      iv. Motion and dynamic state data, including acceleration, angular velocity, and orientation
   b. Storing and analyzing the detected operating parameters using a data processing unit comprising a memory and a processor;
   c. Determining a target tire pressure based on at least one detected operating parameter.
49. The method according to item 48, wherein the vehicle is a motorcycle.
50. The method according to item 48 or item 49, further comprising:
   a. Storing a plurality of tire pressure values in a database using the data processing unit, wherein the tire pressure values are associated with predefined riding modes, such as off-road, street, sport, or eco;
   b. Modifying the target tire pressure based on a manual selection of a riding mode by a user, wherein the target tire pressure corresponds to the tire pressure value associated with the selected riding mode;
51.The method according to item 50, wherein the tire pressure values are also associated with weight parameters, including the weight of the rider, luggage, and/or passengers, and the method further comprises the step of:
   a. Modifying the target tire pressure based on either a manual input of the rider's, luggage's, and/or passengers' weight by a user, or by an automatic determination of the rider's, luggage's, and/or passengers' weight using the sensor system 21, wherein the target tire pressure corresponds to the tire pressure value.
52. The method according to any of the preceding items 48-51, wherein the control unit 19 is in data communication with the data processing unit.
53. The method according to any of the preceding items 48-52, wherein the data processing unit comprises a user interface 41 configured to receive input from a user, wherein the user interface 41 is used for manual selection of a riding mode and/or manual input of the rider's, luggage's, and/or passengers' weight.
54. The method according to item 53, wherein the user interface 41 comprises a mechanical input device such as a button 43, a touch display for entering signals, and/or a microphone for receiving audio signals.
55. The method according to item 53 or item 54, wherein the user interface 41 comprises a mechanical output device such as a vibration motor, a display 46 for presenting visual signals, or a speaker for outputting audio signals.
56. The method according to any of the preceding items 48-55, further comprising:
   a. Detecting road and chassis conditions using the sensor system 21, wherein the detected parameters are selected from the group consisting of:
      Suspension movement and compression patterns averaged over time;
      Chassis vibration or structural displacement data;
      Road condition data obtained from a database based on GPS location;
      Historical onboard road condition data stored in memory and correlated with GPS positioning.
   b. Modifying the target tire pressure based on the road and chassis conditions using the data processing unit;
57. The method according to any of the preceding items 48-56, wherein the sensor system comprises one or more sensors selected from the group consisting of:
   a. A camera configured to detect road conditions or surface properties;
   b. An inertial measurement unit (IMU) configured to capture acceleration, angular velocity, and orientation changes of the vehicle;
   c. A suspension position sensor configured to measure suspension compression level and travel data;
   d. A tire pressure sensor configured to detect the current tire pressure in real-time;
   e. A load sensor configured to determine the weight of the rider, luggage, and/or passengers.

The items of the seventh itemized list can be combined with one or more items of all other itemized lists in this document as well as with one or more features of the claims.

Seventh itemized list:
58. A method for dynamically adjusting tire pressure to enhance vehicle stability and safety, wherein the vehicle comprises a tire pressure management system 1 with an electrically powered compressor 3 mounted on a rim 5, a valve unit 17, a power supply system 7 for providing electrical power to the compressor 3 and a control unit 19 for controlling the compressor 3 and the valve unit 17, the method comprising:
   a. Detecting one or more operating parameters using a sensor system 21, wherein the parameters are selected from the group consisting of:
      i. Activation state of an anti-lock braking system (ABS),
      ii. Road conditions, surface properties and/or Road characteristics, including curvature, incline, and surface irregularities
   b. Analyzing the detected parameters using a data processing unit comprising a memory and a processor to determine a target tire pressure for enhanced stability, braking performance, and accident prevention in critical driving conditions;
   c. Detecting a current tire pressure in a tire using the sensor system 21 and providing the value of the current tire pressure to the data processing unit;
   d. Comparing the current tire pressure with the target tire pressure using the data processing unit;
   e. If the current tire pressure deviates from the target tire pressure or exceeds a predefined threshold, adjusting the tire pressure by:
      i. Activating the compressor 3 to compress a fluid and increase the tire pressure until the target pressure is reached, or
      ii. Activating the valve unit 17 to release fluid the tire into the external atmosphere to decrease the tire pressure until the target pressure is reached.
59. The method according to item 58, wherein the vehicle is a motorcycle.
60. The method according to any of the preceding items 58 or 59, wherein the sensor system 21 comprises one or more sensors selected from the group consisting of:
   a. A communication interface configured to receive the activation state of the anti-lock braking system (ABS) from a vehicle control unit;
   b. A road surface condition sensor, including a camera-based system, infrared, or LiDAR sensor,

The items of the eighth itemized list can be combined with one or more items of all other itemized lists in this document as well as with one or more features of the claims.

Eighth itemized list:
61. A method for dynamically adjusting tire pressure to enhance ride comfort in a vehicle, comprising a tire pressure management system 1 with an electrically powered compressor 3 mounted on a rim 5, a valve unit 17, a power supply system 7 for providing electrical power to the compressor 3 and a control unit 19 for controlling the compressor (3) and the valve unit (17), the method comprising:
   a. Detecting road and chassis conditions using one or more sensors, wherein the detected parameters are selected from the group consisting of:
      i. Suspension movement and compression patterns averaged over time;
      ii. Chassis vibration or structural displacement data;
      iii. Road condition data obtained from a database based on GPS location;
      iv. Historical onboard road condition data stored in memory and correlated with GPS positioning.
   b. Determining a target tire pressure based on the road and chassis conditions using a data processing unit comprising a processor and a memory;
   c. Detecting a current tire pressure in a tire using a sensor and providing the value of the current tire pressure to the data processing unit;
   d. Comparing the current tire pressure with the target tire pressure using the data processing unit;
   e. If the current tire pressure deviates from the target tire pressure or exceeds a predefined threshold, adjusting the tire pressure by:
      i. Activating the compressor 3 to compress a fluid and increase the tire pressure until the target pressure is reached, or
      ii. Activating the valve unit 17 to release fluid the tire into the external atmosphere to decrease the tire pressure until the target pressure is reached.
62. The method according to item 61, wherein the vehicle is a motorcycle.
63. The method according to item 61 or item 62, further comprising:
   a. Storing a plurality of tire pressure values in a database using the data processing unit, wherein the tire pressure values are associated with predefined riding modes, such as off-road, street, sport, or eco;
   a. Modifying the target tire pressure based on a manual selection of a riding mode by a user, wherein the target tire pressure corresponds to the tire pressure value associated with the selected riding mode;
64. The method according to item 63, wherein the tire pressure values are also associated with weight parameters, including the weight of the rider, luggage, and/or passengers, and the method further comprises the step of:
   a. Modifying the target tire pressure based on either a manual input of the rider's, luggage's, and/or passengers; weight by a user, or by an automatic determination of the rider's, luggage's, and/or passengers' weight using the sensor system 21, wherein the target tire pressure corresponds to the tire pressure value.
65. The method according to any of the preceding items 61-64, wherein the control unit 19 is in data communication with the data processing unit.
66. The method according to any of the preceding 61-65, wherein the data processing unit comprises a user interface 41 configured to receive input from a user, wherein the user interface 41 is used for manual selection of a riding mode and/or manual input of the rider's, luggage's, and/or passengers' weight.
67. The method according to item 66, wherein the user interface 41 comprises a mechanical input device such as a button 43, a touch display for entering signals, and/or a microphone for receiving audio signals.
68. The method according to item 66 or item 67, wherein the user interface 41 comprises a mechanical output device such as a vibration motor, a display 46 for presenting visual signals, or a speaker for outputting audio signals.
69. The method according to any of the preceding items 61-68, further comprising:
   a. Detecting, using the sensor system 21, at least one operating parameter selected from the group consisting of:
      Suspension travel data, including compression and rebound speed
      Suspension compression level;
      Road conditions or surface properties,
      Motion and dynamic state data, including acceleration, angular velocity, and orientation
   b. Storing and analyzing the detected operating parameters using the data processing unit;
   c. Modifying the target tire pressure based on at least one detected operating parameter.
70. The method according to any of the preceding items, wherein the sensor system 21 comprises one or more sensors selected from the group consisting of:
   a. A camera configured to detect road conditions or surface properties;
   b. An inertial measurement unit (IMU) configured to capture acceleration, angular velocity, and orientation changes of the vehicle;
   c. A suspension position sensor configured to measure suspension compression level and travel data;
   d. A tire pressure sensor configured to detect the current tire pressure in real-time;
   e. A load sensor configured to determine the weight of the rider, luggage, and/or passengers;
   f. A vibration sensor configured to detect chassis vibrations and structural displacements.

The items of the nineth itemized list can be combined with one or more items of all other itemized lists in this document as well as with one or more features of the claims.

Nineth itemized list:
71. A system 4 for automated tire sealing in a vehicle comprising:
   i. A sealant reservoir 51 integrated within the tire casing of a tire for storing a sealing fluid in a deployable state;
   ii. A sensor system 21 configured to detect a pressure drop or leakage in the tire;
   iii. A sealant shooter mechanism 53, operatively coupled to the sealant reservoir 51, configured to inject a predefined amount of sealing fluid into the inner tire cavity upon detecting a pressure drop or leakage;
   iv. A dispersion mechanism, utilizing the natural rotation of the tire to distribute the sealing fluid across the inner surface.
72. The system 4 according to item 71, wherein the vehicle is a motorcycle.
73. The system 4 according to item 71 or item 72, wherein the sealant reservoir 51 is positioned along the rim well 6 of a rim 5 of the tire and is fluidly isolated from the tire's internal air volume until activation.
74. The system 4 according to any of the preceding items 71-73, wherein the sealant shooter mechanism 53 comprises a pressurized injection system, including a micro-pump or a CO₂ cartridge-based expulsion unit 55.
75. The system 4 according to any of the preceding items 71-74, wherein the sensor system 21 comprises one or more sensors selected from the group consisting of:
   i. A tire pressure sensor configured to detect the current tire pressure in real-time.
76. The system 4 according to any of the preceding items 71-75, further comprising an automated valve control unit that regulates the injection timing and volume of the sealant fluid based on the severity of the pressure drop.
77. The system 4 according to any of the preceding items 71-76, wherein the sealant fluid includes a self-curing polymer-based composition capable of sealing punctures up to a predefined size threshold.
78. The system 4 according to any of the preceding items 71-77, further comprising a control unit that communicates with a tire pressure management systems 1 to provide real-time feedback on tire status and sealing effectiveness.
79. The system 4 according to any of the preceding items 71-78, the tire pressure management system 1 comprises an electrically powered compressor 3 mounted on a rim 5, a valve unit 17, a power supply system 7 for providing electrical power to the compressor 3 and a control unit 19 for controlling the compressor 3 and the valve unit 17.

The items of the eleventh itemized list can be combined with one or more items of all other itemized lists in this document as well as with one or more features of the claims.

Eleventh itemized list:
80. A tire pressure management system 1 for a vehicle comprising:
   a. a tire cavity having a working volume configured to contain an air volume for maintaining an operating tire pressure;
   b. a means 57 located within the tire cavity for increasing and decreasing the working volume of the tire cavity to adjust the internal tire pressure;
   c. a control unit 19 configured to regulate the means 57 for increasing and decreasing the working volume of the tire cavity to achieve a target pressure;
   d. a power supply system configured to provide power to the control unit 19 and/or the means 57.
81. The system 1 according to item 80, wherein the vehicle is a motorcycle.
82. The system 1 according to item 80 or item 81, wherein the means 57 comprise a cylinder 59 with a sealed piston 61 configured to extend and retract to modify the working volume of the tire cavity, thereby adjusting the internal tire pressure, wherein the piston 61 is operably coupled to an electric motor 63 powered by the power supply system and/or the control unit 19.
83. The system 1 according to item 80 or item 81, wherein the means 57 comprises one or more of the following: bladders, membranes, solenoids, motors, or other actuators, all operably connected to the power supply system and the control unit 19, and configured to modify the working volume of the tire cavity.
84. A method for controlling the tire pressure of a vehicle, the vehicle comprising a tire cavity with a working volume, the method comprising the steps of:
   a. Adjusting the working volume of the tire cavity using a means 57 located within the tire cavity to selectively increase or decrease the internal tire pressure;
   b. Regulating the means for adjusting the working volume via a control unit 19 to achieve a target tire pressure;
   c. Providing electrical power to the control unit 19 and/or the means 57 for adjusting the working volume through a power supply system.

It is apparent that the further following relationship between the items holds:
85. The method according to any of the preceding items 38-70 and/or the system according to any of the preceding items 71-78, wherein the tire pressure management system 1 comprises the features of the tire pressure management system 1 according to items 1-31 and/or the features of the tire pressure management system 1 according to items 80-83.

The items of the twelfth itemized list can be combined with one or more items of all other itemized lists in this document as well as with one or more features of the claims.

Twelfth itemized list:
86. An electric tire heating system for a vehicle, comprising:
   a heating element mounted in a tire casing or within a tire cavity of a wheel assembly 2 the heating element being configured to generate heat to raise the temperature of a tire;
   a power supply system configured to provide electrical power to the heating element;
   at least one temperature sensor 21 configured to detect the temperature of the tire, the tire cavity, and/or the tire tread;
   a control unit 19 located in or on the wheel assembly 2, the control unit 19 being in signal communication with a user interface 41, the heating element and/or the at least one temperature sensor 21, and comprising a microprocessor configured to:
      receive user commands via the user interface 41,
      control the operation of the heating element based on user commands and/or temperature sensor data, and
      transmit data to the user interface.
87. The system according to item 86, wherein the vehicle is a motorcycle.
88. The system according to item 86 or 87, wherein the power supply system comprises an inductive power transfer system 7, including:
   a first coil 9 positioned at a vehicle axle 13, and
   a second coil 11 positioned at a hub 15 of the rim 5, wherein the second coil 11 is configured to inductively receive power from the first coil 9 and supply it to the heating element.
89. The system according to item 88, wherein the first coil 9 is connected to a vehicle power source 23, such as a battery.
90. The system according to item 88 or item 89, wherein the first coil 9 comprises a plurality of windings applied around the circumference of the axle 13.
91. The system according to item 90, the axle 13 is hollow and comprises axle walls 25 that define an interior cavity 27, a first cable 31 extending from the vehicle's power source 23 is routed through the interior cavity 27 of the axle 13, and the first coil 9 is electrically connected to the first cable 31 through an opening in the axle wall 25.
92. The system according to any of the preceding items 88-91, wherein the transformer-based inductive power supply system 7 is further configured to transmit bidirectional signals, such as control signals, using methods such as pulse-code modulation.
93. The system according to any of the preceding items 88-92, wherein the second coil 11 is connected to the heating element via a second cable 33, the second cable being 33 routed radially outward from the hub 15 of the rim 5 to the heating element and/or control unit 19, wherein the heating element and the control unit 19 are located in the rim well 6, the rim well 6 comprising an opening through which the second cable 33 is routed.
94. The system according to any of the preceding items 88-93, wherein the second coil 11 is integrated into a bearing assembly 35 that is positioned in the hub 15 of the rim 5 and allows the rim 5 to rotate around the axle 13, wherein the second coil 11 is positioned in the bearing assembly 35, such that a magnetic field generated by the first coil 9 induces a current in the second coil 11 when the rim 5 rotates.
95. The system according to item 94, wherein the second coil 11 is integrated within the bearing assembly 35, such that the second coil 11 surrounds the first coil 9 when the rim 5 is mounted on the axle 13.
96. The system according to any preceding items 86-95, wherein the heating element is adhered to an inner surface of the tire or integrated into the tire structure.
97. The system according to any preceding items 86-96, wherein the temperature sensor 21 is positioned inside the tire cavity, on the inner liner, or externally directed toward the tread.
98. The system according to any preceding items 86-97, wherein the control unit 19 is configured to automatically activate or deactivate the heating element based on predefined temperature thresholds.
99. The system according to item 98, wherein the predefined thresholds are set based on riding mode, ambient temperature, or tire type.
100. The system according to any preceding items 86-100, wherein the user interface 41 is positioned on the handlebar or integrated into a mobile device.
101. The system according to any preceding items 86-101, wherein the user interface 41 comprises a mechanical input device, a touchscreen, and/or a voice input module.
102. The system according to item 101, wherein the user interface 41 further comprises a display, a speaker, or a vibration feedback mechanism.
103. The system according to any preceding items 86-102, wherein the control unit 19 and/or heating element are configured to operate in a power-saving mode.
104. The system according to any preceding item 86-103, wherein the power supply system comprises a rechargeable energy storage device, such as a battery or supercapacitor, located within the wheel assembly 2.
105. The system according to item 104, wherein the energy storage device is charged via the inductive power transfer system.
106. The system according to any preceding items 86-105, wherein the system includes a wireless communication interface enabling communication with external devices.
107. The system according to item 106, wherein the wireless communication interface supports Bluetooth® or Wi-Fi®.
108. The system according to any preceding items 86-107, wherein the heating element comprises a resistive wire, a printed conductive film, or a flexible heating mat.
109. The system according to any preceding items 86-108, wherein the control unit 19 logs temperature profiles over time.
110. The system according to item 109, wherein logged data is transmitted to a cloud service or mobile app.
111. The system according to any preceding items 86-110, wherein the system is configured to provide different heating profiles for warm-up, rain, and racing modes.
112. The system according to item 111, wherein the control unit 19 adjusts the heating intensity and duration based on the selected profile.
113. A vehicle comprising at least one electric tire heating system according to any of the preceding item 86-112.
114. The vehicle according to item 114, wherein both front and rear wheels are equipped with the system and are controlled via a single user interface.
115. A method for heating a tire of a vehicle, comprising:
   providing a system according to any of items 86 to 112 or a vehicle according to items 113 or 114;
   inputting a desired heating mode or temperature via the user interface 41;
   detecting the tire temperature using the temperature sensor 21;
   activating or deactivating the heating element based on the detected temperature and user input.
116. The method according to item 115, wherein the vehicle is a motorcycle.
117. The method according to item 115 or 116, wherein the heating mode is selected from a group consisting of: warm-up mode, rain mode, sport mode, and energy-saving mode.
118. The method according to any of items 115 to 117, further comprising logging the tire temperature data over time and transmitting it to a mobile application or cloud service.
119. The method according to any of items 115 to 118, wherein the heating is automatically activated based on ambient temperature or time schedule.
120. The method according to any of items 115 to 119, further comprising charging a local energy storage device prior to heating activation.
121. The method according to any of items 115 to 120, wherein the user input is provided via a handlebar-mounted interface or a wireless mobile device.
122. The method according to any of items 115 to 121, wherein heating is disabled automatically when the vehicle exceeds a predefined speed threshold or braking event is detected.

The items of the thirteenth itemized list can be combined with one or more items of all other itemized lists in this document as well as with one or more features of the claims.

Thirteenth itemized list:
123. A method for controlling the tire pressure of a tire in a vehicle comprising a tire pressure management system 1 with an electrically powered compressor 3 mounted on a rim 5, a valve unit 17, a power supply system 7 for providing electrical power to the compressor 3 and a control unit 19 for controlling the compressor 3 and the valve unit 17, the method comprising:
   a. Storing a plurality of tire pressure values in a database using a data processing unit comprising at least a memory and a processor, wherein the tire pressure values are associated with predefined riding modes, such as off-road, street, sport, or eco;
   b. Determining a target tire pressure based on a manual selection of a riding mode by a user, wherein the target tire pressure corresponds to the tire pressure value associated with the selected riding mode;
   c. Detecting a current tire pressure in a tire using a sensor system 21 and providing the value of the current tire pressure to the data processing unit;
   d. Comparing the current tire pressure with the target tire pressure using the data processing unit;
   e. If the current tire pressure deviates from the target tire pressure or exceeds a predefined threshold, adjusting the tire pressure by:
      i. Activating the compressor 3 to compress a fluid and increase the tire pressure until the target pressure is reached, or
      ii. Activating the valve unit 17 to release fluid the tire into the external atmosphere to decrease the tire pressure until the target pressure is reached.
124. The method according to item 123, wherein the vehicle is a motorcycle.
125. The method according to item 123, wherein the tire pressure values are also associated with weight parameters, including the weight of the rider, luggage, and/or passengers, and the method further comprises the step of:
   i. Modifying the target tire pressure based on either a manual input of the rider's, luggage's, and/or passengers' weight by a user, or by an automatic determination of the rider's, luggage's, and/or passengers' weight using the sensor system 21.
126. The method according to item 123, wherein the control unit 19 is in data communication with the data processing unit.
127. The method according to item 123, wherein the data processing unit comprises a user interface 41 configured to receive input from a user, wherein the user interface 41 is used for manual selection of a riding mode and/or manual input of the rider's, luggage's, and/or passengers' weight.
128. The method according to item 127, wherein the user interface 41 comprises a mechanical input device such as a button 43, a touch display for entering signals, and/or a microphone for receiving audio signals.
129. The method according to item 127, wherein the user interface 41 comprises a mechanical output device such as a vibration motor, a display 46 for presenting visual signals, or a speaker for outputting audio signals.
130. The method according to item 123, further comprising:
   a. Detecting, using the sensor system 21, at least one operating parameter selected from the group consisting of:
      Suspension travel data, including compression and rebound speed
      Suspension compression level;
      Road conditions or surface properties,
      Motion and dynamic state data, including acceleration, angular velocity, and orientation
   b. Storing and analyzing the detected operating parameters using the data processing unit;
   c. Modifying the target tire pressure based on at least one detected operating parameter.
131. The method according to item 123, further comprising:
   a. Detecting road and chassis conditions using the sensor system 21, wherein the detected parameters are selected from the group consisting of:
      Suspension movement and compression patterns averaged over time;
      Chassis vibration or structural displacement data;
      Road condition data obtained from a database based on GPS location;
      Historical onboard road condition data stored in memory and correlated with GPS positioning.
   b. Modifying the target tire pressure based on the road and chassis conditions using the data processing unit;
132. The method according to item 123, wherein the off-road riding mode is associated with a target tire pressure between about 12 psi and about 18 psi to enhance traction on loose surfaces such as dirt, sand, or gravel.
133. The method according to item 123, wherein the sport riding mode is associated with a target tire pressure between about 33 psi and about 42 psi to improve handling, cornering stability, and responsiveness on paved roads at high speeds.
134. The method according to item 123, wherein the street riding mode is associated with a target tire pressure between about 29 psi and about 36 psi to ensure a balance between comfort, tire wear, and fuel efficiency for general road use.
135. The method according to item 123, wherein the eco riding mode is associated with a target tire pressure between about 36 psi and about 44 psi to minimize rolling resistance and improve fuel efficiency.
136. The method according item 123, wherein the sensor system 21 comprises one or more sensors selected from the group consisting of:
   a. A camera configured to detect road conditions or surface properties;
   b. An inertial measurement unit (IMU) configured to capture acceleration, angular velocity, and orientation changes of the vehicle;
   c. A suspension position sensor configured to measure suspension compression level and travel data;
   d. A tire pressure sensor configured to detect the current tire pressure in real-time;
   e. A load sensor configured to determine the weight of the rider, luggage, and/or passengers;
   f. A vibration sensor configured to detect chassis vibrations and structural displacements.
137. The method according item 123, wherein the electrically powered compressor 3 is integrated within a tire casing.
138. The method according to item 123, wherein the valve unit 17 enables bidirectional fluid flow to regulate tire pressure, operatively coupled to the compressor 3 to establish fluid communication between the compressor 3 and the external atmosphere.
139. The method according to item 123, wherein the control unit 19 comprises a microprocessor in signal communication with the compressor 3, the reservoir 44 and/or the valve unit 17, and wherein the control unit is configured to receive commands from the data processing unit to adjust tire pressure by controlling the compressor 3, the reservoir 44, and/or the valve unit 17 based on the commands.
140. The method according to item 123, wherein the power supply system 7 comprises a transformer-based inductive power supply system for providing electrical power to the compressor 3, the transformer-based inductive power supply system comprising:
   a. a first coil 9 positioned at a vehicle axle, such as a motorcycle axle 13, configured to generate a magnetic field; and
   b. a second coil 11 attached to a hub 15 of the rim 5, configured to inductively receive power from the first coil 9 during operation and supply it to the compressor 3.
141. The method according to item 140, wherein the first coil 9 is electrically connected to a power source 23 of the vehicle, particularly to a battery.
142. The method according to item 140, wherein the first coil 9 comprises a plurality of windings applied around the circumference of the axle 13.

What is claimed is:

1. A tire pressure management system for controlling tire pressure of a tire of a vehicle, the system comprising:
an electrically powered compressor mounted on a rim;
a valve unit;
a power supply system configured to provide electrical power to the compressor;
a control unit configured to control the compressor and the valve unit;
a sensor system configured to detect a current tire pressure in the tire and to automatically determine weight of a rider, luggage, or passengers;
a data processing unit comprising at least a memory and a processor; and
a database implemented in the memory of the data processing unit and storing a plurality of tire pressure values, wherein the tire pressure values are associated with predefined riding modes, including off-road, street, sport, or eco, or with weight parameters, including weight of the rider, luggage, or passengers,
wherein the data processing unit is configured to:
determine a target tire pressure based on:
(i) a manual selection of a riding mode by a user, or
(ii) a manual input of the rider's, luggage's, or passengers' weight by a user, or
(iii) an automatic determination of the rider's, luggage's, or passengers' weight using the sensor system,
wherein the target tire pressure corresponds to the tire pressure value associated with the selected riding mode or with the manually entered or automatically determined weight;
receive from the sensor system a value indicative of the current tire pressure;
compare the current tire pressure with the target tire pressure; and
in response to the current tire pressure deviating from the target tire pressure or exceeding a predefined threshold, cause:
activation of the compressor to compress a fluid and increase the tire pressure until the target tire pressure is reached; or
activation of the valve unit to release fluid from the tire into the external atmosphere to decrease the tire pressure until the target tire pressure is reached.

2. The system of claim 1, wherein the vehicle is a motorcycle.

3. The system of claim 1, wherein the control unit is in data communication with the data processing unit.

4. The system of claim 1, wherein the data processing unit comprises a user interface configured to receive input from a user, wherein the user interface is used for manual selection of a riding mode and/or manual input of the rider's, luggage's, and/or passengers' weight.

5. The system of claim 4, wherein the user interface comprises a mechanical input device such as a button, a touch display for entering signals, and/or a microphone for receiving audio signals.

6. The system of claim 1, wherein the sensor system comprises one or more sensors selected from the group consisting of:
a. A tire pressure sensor configured to detect the current tire pressure in real-time;
b. A load sensor configured to determine the weight of the rider, luggage, and/or passengers.

7. The system of claim 1, wherein the off-road riding mode is associated with a target tire pressure between about 12 psi and about 18 psi to enhance traction on loose surfaces such as dirt, sand, or gravel.

8. The system of claim 1, wherein the sport riding mode is associated with a target tire pressure between about 33 psi and about 42 psi to improve handling, cornering stability, and responsiveness on paved roads at high speeds.

9. The system of claim 1, wherein the street riding mode is associated with a target tire pressure between about 29 psi and about 36 psi to ensure a balance between comfort, tire wear, and fuel efficiency for general road use.

10. The system of claim 1, wherein the eco riding mode is associated with a target tire pressure between about 36 psi and about 44 psi to minimize rolling resistance and improve fuel efficiency.

11. The system of claim 1, wherein the electrically powered compressor is disposed within an interior volume enclosed by the tire.

12. The system of claim 1, wherein the valve unit enables bidirectional fluid flow to regulate tire pressure and is operatively coupled to the compressor to establish fluid communication between the compressor and the external atmosphere.

13. The system of claim 1, wherein the power supply system comprises a transformer-based inductive power supply system for providing electrical power to the compressor, the transformer-based inductive power supply system comprising:
a. a first coil positioned at a vehicle axle, such as a motorcycle axle, configured to generate a magnetic field; and
b. a second coil attached to a hub of the rim, configured to inductively receive power from the first coil during operation and supply it to the compressor.

14. The system of claim 13, wherein the first coil is electrically connected to a power source of the vehicle, particularly to a battery.

15. A method for dynamically adjusting tire pressure to enhance ride comfort in a vehicle, comprising a tire pressure management system with an electrically powered compressor mounted on a rim, a valve unit, a power supply system for providing electrical power to the compressor and a control unit for controlling the compressor and the valve unit, the method comprising:
a. Detecting road and chassis conditions using a sensor system, wherein the detected road and chassis conditions are based on parameters selected from the group consisting of:
i. Suspension movement and compression patterns averaged over time;
ii. Chassis vibration or structural displacement data;
iii. Road condition data obtained from a database based on GPS location;
iv. Historical onboard road condition data stored in memory and correlated with GPS positioning.
b. Determining a target tire pressure based on the road and chassis conditions using a data processing unit comprising a processor and a memory;
c. Detecting a current tire pressure in a tire using the sensor system and providing the value of the current tire pressure to the data processing unit;
d. Comparing the current tire pressure with the target tire pressure using the data processing unit;
e. If the current tire pressure deviates from the target tire pressure or exceeds a predefined threshold, adjusting the tire pressure by:
v. Activating the compressor to compress a fluid and increase the tire pressure until the target pressure is reached, or
vi. Activating the valve unit to release fluid from the tire into the external atmosphere to decrease the tire pressure until the target pressure is reached.

16. The method of claim 15, wherein the vehicle is a motorcycle.

17. The method of claim 15, wherein the sensor system comprises one or more sensors selected from the group consisting of:
a. A camera configured to detect road conditions or surface properties;
b. A suspension position sensor configured to measure suspension compression level and travel data;
c. A tire pressure sensor configured to detect the current tire pressure in real-time;
d. A vibration sensor configured to detect chassis vibrations and structural displacements.
e. A position sensor, such as a GPS-Sensor.

18. A method for dynamically adjusting tire pressure to enhance vehicle stability and safety, wherein the vehicle comprises a tire pressure management system with an electrically powered compressor mounted on a rim, a valve unit, a power supply system for providing electrical power to the compressor and a control unit for controlling the compressor and the valve unit, the method comprising:
a. Detecting one or more operating parameters using a sensor system, wherein the parameters are selected from the group consisting of:
i. Activation state of an anti-lock braking system (ABS),
ii. Road conditions, surface properties and/or Road characteristics, including curvature, incline, and surface irregularities
iii. Suspension travel data, including compression and rebound speed
iv. Suspension compression level;
v. Motion and dynamic state data, including acceleration, angular velocity, and orientation;
b. Storing and analyzing the detected operating parameters using a data processing unit comprising a memory and a processor to determine a target tire pressure for enhanced stability, braking performance, and accident prevention in critical driving conditions;
c. Detecting a current tire pressure in a tire using the sensor system and providing the value of the current tire pressure to the data processing unit;
d. Comparing the current tire pressure with the target tire pressure using the data processing unit;
e. If the current tire pressure deviates from the target tire pressure or exceeds a predefined threshold, adjusting the tire pressure by:
i. Activating the compressor to compress a fluid and increase the tire pressure until the target pressure is reached, or
ii. Activating the valve unit to release fluid from the tire into the external atmosphere to decrease the tire pressure until the target pressure is reached.

19. The method of claim 18, wherein the vehicle is a motorcycle.

20. The method of claim 18, wherein the sensor system comprises one or more sensors selected from the group consisting of:
a. An inertial measurement unit (IMU) configured to capture acceleration, angular velocity, and orientation changes of the vehicle;
b. A suspension position sensor configured to measure suspension compression level and travel data;
c. A tire pressure sensor configured to detect the current tire pressure in real-time;
d. A communication interface configured to receive the activation state of the anti-lock braking system (ABS) from a vehicle control unit;
e. A road surface condition sensor, including a camera-based system, infrared, or LiDAR sensor.
